(19) United States
(12) Patent Application Publication
(10) Pub. No.: US 2026/0052591 A1
(43) Pub. Date: Feb. 19, 2026

(54) NETWORK NODES, COMMUNICATION DEVICES AND METHODS FOR HANDLING MULTI-HOP CONFIGURATION IN A WIRELESS COMMUNICATION NETWORK

(71) Applicant: Telefonaktiebolaget LM Ericsson (publ), Stockholm (SE)

(72) Inventors: Sladana JOSILO, Solna (SE); Lian ARAUJO, Solna (SE); Cecilia EKLÖF, Taby (SE); Icaro Leonardo DA SILVA, Solna (SE); Jens BERGQVIST, Linkoping (SE)

(21) Appl. No.: 19/102,138

(22) PCT Filed: Aug. 9, 2023
(86) PCT No.: PCT/SE2023/050801

§ 371 Date: Feb. 7, 2025

Related U.S. Application Data
(60) Provisional application No. 63/370,836, filed on Aug. 9, 2022.

(51) Int. Cl. H04W 76/15; H04W 36/00

(52) U.S. Cl. CPC H04W 76/15; H04W 36/0069

(57) ABSTRACT

Network nodes and methods therein for handling multi-hop configuration of conditional primary secondary cell change or primary secondary cell group cell change (CPC) for a communication device (530, 531) configured with dual connectivity with a master cell group (MCG) managed by a first network node (511), and a secondary cell group (SCG) managed by the second network node (512), in a wireless communication network (500) are provided. Different solutions for enabling multi-hop CPC configurations and implementations of these solutions from the perspective of the first network node (511), the second network node (512), a target candidate network node and the communication device (530, 531) are disclosed.

### TECHNICAL FIELD

Embodiments herein relate to network nodes, communication devices and methods therein. In particular, they relate to handling multi-hop conditional primary secondary cell (PSCell) or primary secondary cell group cell change (CPC) configuration for a communication device operating in dual connectivity with a master cell group (MCG) and a secondary cell group (SCG) in a wireless communication network.

### BACKGROUND

In a typical wireless communication network, wireless devices, also known as wireless communication devices, mobile stations, stations (STA) and/or user equipment (UE), communicate via a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a “NodeB” or “eNodeB” or “gNB”. A service area or cell area is a geographical area where radio coverage is provided by the radio network node. The radio network node communicates over an air interface operating on radio frequencies with the wireless communication device within a range of the radio network node.

A Universal Mobile Telecommunications System (UMTS) is a third generation (3G) telecommunication network, which evolved from the second generation (2G) Global System for Mobile Communications (GSM). Specifications for the Evolved Packet System (EPS), also called a Fourth Generation (4G) network or Long Term Evolution (LTE) have been completed within the 3rd Generation Partnership Project (3GPP) and this work continues in the coming 3GPP releases, for example to specify a Fifth Generation (5G) New Radio (NR) network and upcoming releases.

### 3GPP Dual Connectivity:

In 3GPP Rel-12, the LTE feature Dual Connectivity (DC) was introduced, to enable a UE to be connected in two cell groups, each controlled by an LTE access node, eNBs, labelled as the Master eNB (MeNB) and the Secondary eNB (SeNB). The UE still only has one Radio Resource Control (RRC) connection with the network node. In 3GPP, the Dual Connectivity (DC) solution has since then been evolved and is now also specified for NR as well as between LTE and NR. With introduction of 5G, the term Multi-Radio Dual Connectivity (MR-DC), see also 3GPP TS 37.340, was defined as a generic term for all dual connectivity options which includes at least one NR access node. Using the MR-DC generalized terminology, a UE is connected in a Master Cell Group (MCG), controlled by the Master Node (MN), and in a Secondary Cell Group (SCG) controlled by a Secondary Node (SN).

Further, in MR-DC, when dual connectivity is configured for a UE, within each of the two cell groups, MCG and SCG, carrier aggregation may be used as well. In this case, within the MCG, controlled by the master node (MN), the UE may use one Primary Cell (PCell) and one or more Secondary Cells (SCell(s)). And within the SCG, controlled by the secondary node (SN), the UE may use one Primary SCell (PSCell), also known as the primary SCG cell in NR, and one or more SCell(s). This combined case, i.e. dual connectivity combined with carrier aggregation in MR-DC, is illustrated in FIG. 1, where a master node MN 110, a secondary node SN 120, a UE 130, a master cell group MCG 140, a secondary cell group SCG 150, a primary cell PCell 160 in MCG 140, a Primary SCell PSCell 170 in the SCG 150, and multiple SCells are shown. In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE, also referred to as Evolved Universal Terrestrial Radio Access (E-UTRA) and evolved packet core (EPC). In principle, NR and LTE can be deployed without any interworking, denoted by NR stand-alone (SA) operation, also known as Option 2, that is gNB in NR can be connected to 5G core network (5GC) and eNB in LTE can be connected to EPC with no interconnection between the two, also known as Option 1.

However, the first supported version of NR that uses dual connectivity, is Evolved Universal Terrestrial Radio Access Network-NR (E-UTRAN-NR) Dual Connectivity (EN-DC), also known as Option 3, as depicted in FIG. 2. In such a deployment, dual connectivity between NR and LTE is applied, where a UE 210 is connected both to an LTE access node LTE MeNB 220 with the LTE radio interface LTE Uu 221 and to an NR access node NR SgNB 230 with the NR radio interface NR Uu 231. Further, in EN-DC, the LTE access node acts as the master node, in this case known as the Master eNB (MeNB), controlling the master cell group (MCG), and the NR access node acts as the secondary node, in this case sometimes also known as the Secondary gNB (SgNB), controlling the secondary cell group (SCG). The SgNB may not have a control plane connection to the core network EPC 240 which instead is provided by MeNB and in this case the NR. This is also called as “Non-standalone NR” or, in short, “NSA NR”. Notice that in this case the functionality of an NR cell is limited and would be used for connected mode UEs as a booster and/or diversity leg, but a UE in RRC_IDLE state in which the UE is switched on but does not have any established RRC connection, cannot camp on these NR cells.

With introduction of 5GC, other options may be also valid. As mentioned above, option 2 supports stand-alone NR deployment where gNB is connected to 5GC. Similarly, LTE can also be connected to 5GC using option 5, also known as eLTE, E-UTRA/5GC, or LTE/5GC and the node can be referred to as an ng-eNB. In these cases, both NR and LTE are seen as part of the NG-RAN and both the ng-eNB and the gNB can be referred to as NG-RAN nodes.

It is worth noting that, there are also other variants of dual connectivity between LTE and NR which have been standardized as part of NG-RAN connected to 5GC. Under the MR-DC umbrella, we have:
EN-DC (Option 3): LTE is the master node and NR is the secondary node, EPC CN employed, as depicted in FIG. 2.
NE-DC (Option 4): NR is the master node and LTE is the secondary, 5GCN employed.
NGEN-DC (Option 7): LTE is the master node and NR is the secondary, 5GCN employed.
NR-DC (variant of Option 2): Dual connectivity where both the master node (MN) controlling the MCG, and the secondary node (SN) controlling the SCG, are NR, 5GCN employed, as depicted in FIG. 3.

### Conditional PSCell Change (CPC) in 3GPP Rel-16:

A solution for CPC procedure was also standardized in 3GPP Rel-16. Therein a UE operating in Multi-Radio Dual Connectivity (MR-DC) receives in a conditional reconfiguration one or multiple RRC Reconfiguration(s), e.g. an RRCReconfiguration message, containing an SCG configuration, e.g. an secondaryCellGroup of IE CellGroupConfig with a reconfigurationWithSync that is stored and associated to an execution condition, e.g. a condition like an A3/A5 event configuration, so that one of the stored messages is only applied upon the fulfilment of the execution condition, e.g. associated with the serving PSCell, upon which the UE would perform PSCell change, in case it finds a neighbour cell that is better than the current SpCell of the SCG. Only intra-SN CPC without MN involvement is standardized in 3GPP Rel-16, i.e., for cases where the candidate target PSCells are located in the current serving SN.

Similar to conditional handover, in case a random access was performed for a target PSCell and the UE was configured with CPC, the UE then releases all the conditional reconfigurations that it has stored.

### Conditional PSCell Addition (CPA) and Inter-SN CPC in 3GPP Rel-17:

In 3GPP Rel-17 solutions for CPA and inter-SN CPC are being discussed and introduced. The CPA procedure is used for adding a PSCell/SCG to the configuration for a UE that is currently only configured with an MCG, when associated execution conditions are fulfilled. CPA is initiated by the MN by requesting an SCG configuration, which is to be provided as part of a conditional reconfiguration to the UE, from a candidate target SN (T-SN), and then sending it in a conditional reconfiguration to the UE together with the associated execution conditions.

The inter-SN CPC can be initiated either by the MN or by the source SN (S-SN), where the signalling towards the source SN and the candidate target SNs, as well as towards the UE, in both cases they are handled by the MN. One of the possible signalling sequences for configuration of an inter-SN CPC, which is initiated by the source SN as illustrated in the signalling flow in FIG. 4 showing inter-SN CPC in 3GPP Rel-17.

Also, for Rel-17 Conditional PSCell change (CPC)/Conditional PSCell addition (CPA), it can be expected that the UE configured with CPC/CPA has to release the CPC/CPA configurations when completing random access towards the target PSCell.

NR-DC with Selective Activation of the Cell Groups (at Least for SCG) Via L3 Enhancements in 3GPP Rel-18:

For 3GPP Rel-18, work is starting up to introduce enhancements for different mobility procedures, with a Work Item Description in RP-213565, New WI: Further NR mobility enhancements, MediaTek, 3GPP TSG RAN Meeting #94e, Dec. 6-17, 2021. One of the current objectives is “to specify mechanism and procedures of NR-DC with selective activation of the cell groups (at least for SCG) via L3 enhancements”, which includes “to allow subsequent cell group change after changing CG without reconfiguration and re-initiation of CPC/CPA”.

Therefore, it should be possible to perform a subsequent cell group change after a first cell group change, without reconfiguring or re-initiation Conditional PSCell Change (CPC) or Conditional PSCell Addition (CPA). This would then be done in order to reduce the interruption time and the signalling overhead for SCG changes, especially in the case of frequent SCG changes when operating in Frequency Range 2 (FR2) in NR, compared to when these configurations are released when the UE completes random access towards the target PSCell, as in the previous releases.

### Full vs Delta Configuration:

As part of mobility preparation to a target node, the source node sends the current UE configuration to the target node. The target node prepares a target configuration for the UE based on the current configuration and the target node's and the UE's capabilities. The target configuration is sent from the target node to the source node and onwards to the UE in RRCReconfiguration. As a streamlined option, the target configuration can be provided as a so called delta-configuration, indicating only the differences from the UE's current configuration in the source cell.

However, in some cases, e.g. if the target node does not recognize something in the UE's current configuration e.g. due to that the target node does not support some feature which the source node supports, the target node will trigger a full configuration. A full configuration means that the UE will clear the current configuration and make a new configuration from scratch. This is further described in section 5.3.5.11 in TS 38.331 V16.7.0 and referred to as “full configuration” or “fullConfig”.

The full configuration may also be used at mobility if the network node prefers to signal the whole UE target configuration instead of signalling a delta configuration towards the source cell, e.g., if delta configuration is complex to build.

In the following, The terms “communication device” and “UE” are used interchangeably. The terms “network node”, “gNB”, “eNB”, “gNodeB are used interchangeably.

### SUMMARY

As part of developing embodiments herein problems were identified and will first be discussed.

According to 3GPP Rel-17 solutions, the CPC can be configured only “one hop ahead”, i.e., a UE operating in MR-DC and configured with Cell A as a source cell, can receive one or multiple RRC Reconfiguration(s) for one or multiple target cells e.g., Cell B and Cell C. However, the existing solutions do not support “multiple hops ahead” CPC configuration. Therefore, the existing 3GPP Rel-17 solutions allow only for the subsequent cell group change with reconfiguring or re-initiating CPC, which may introduce significant interruption times and the signaling overhead in the case of frequent SCG changes that are likely to happen when operating in FR2 in NR.

It is therefore an object of embodiments herein to provide an improved method for handling multi-hop CPC configuration for a UE or a communication device.

Embodiments herein include different solutions for configuring a UE with a CPC configuration including a configuration for a target candidate PSCell, comprising an SCG configuration and an MCG configuration, to be applied upon fulfilment of a first CPC execution condition, wherein the configuration for a target candidate PSCell also includes at least one embedded CPC configuration that is valid in that new PSCell.

In particular, the solutions address the following aspects:
the actions that need to be performed by the MN,
the actions that need to be performed by the source SN,
the actions that need to be performed by target candidate SNs,
the actions that need to be performed by the UE,
the content of the conditional reconfiguration, such as whether it contains the information concerning multiple CPC hops, or a single CPC hop,
signalling in the case of MN involvement into the CPC configuration,
signalling in the case when there is no MN involvement into the CPC configuration,
signalling in the case when each hop CPC is MN initiated,
signalling in the case when each hop CPC is SN initiated,
signalling in the case when CPC configurations are MN initiated in some hops and SN initiated in some other hops,
signalling in the case of the inter CPC multi-hop configurations,
signalling in the case of the intra CPC multi-hop configurations,

signalling in the case of the hybrid, e.g., inter-intra or intra-inter, CPC multi-hop configurations. According to one aspect of embodiments herein, the object is achieved by a first network node and method therein for handling multi-hop CPC for a communication device configured with dual connectivity with MCG managed by the first network node and a SCG managed by a second network node in a wireless communication network. The first network node transmits a request for CPC to the second network node or a first target candidate Secondary Node (SN), receives a message from the second network node or the first target candidate SN in response to the request for CPC. The message may comprises one or more of the following information:
i. an indication indicating that the CPC configuration is a multi-hop CPC configuration,
ii. an indication about whether it is time critical to configure a first hop CPC;
iii. an indication about how many hops ahead to be configured;
iv. identifier(s) of one or more target candidate primary secondary cells, PSCells, for the second hop CPC configuration,
v. identifier(s) of one or more target candidate secondary node(s) (T-SN2) associated to the one or more target candidate PSCells.

The first network node configures multi-hop CPC for the communication device 530, 531 based on the received message.

According to one aspect of embodiments herein, the object is achieved by a second network node and method therein for handling multi-hop CPC configuration for a communication device configured with dual connectivity with MCG managed by a first network node and a SCG managed by the second network node in a wireless communication network. The second network node transmits a request for CPC to the first network node or the communication device. The request for CPC comprises any one or more of the following information:
an indication indicating allowing multi-hop CPC;
an indication indicating the maximum number of allowed CPC hops;
a configuration for a first hop intra-SN CPC;
a configuration for subsequent hops intra-SN CPCs;
a configuration for a second hop inter-SN CPC to another target candidate SN;
an indication indicating whether a next CPC hop configuration is allowed.

According to one aspect of embodiments herein, the object is achieved by a first target candidate secondary node and method therein for handling multi-hop CPC configuration for a communication device configured with dual connectivity with MCG managed by a first network node and a SCG managed by a second network node in a wireless communication network. The first target candidate secondary node receives a request for CPC from the first network node, configures multi-hop CPC by configuring a first hop CPC and including information on a second hop CPC or configuring a first hop CPC and initiating a configuration for a second hop CPC towards a second candidate secondary node (T-SN2), sends a response message to the first network node. The response message comprises one or more of the following information:
i. an indication that this is a multi-hop CPC configuration,
ii. identifier(s) of one or more target candidate cells for the next or a later hop CPC configuration,
iii. identifier(s) of one or more Target Candidate SN(s) associated to the one or more target candidate cells.

According to one aspect of embodiments herein, the object is achieved by a communication device and method therein for handling multi-hop CPC configuration. The communication device is configured with dual connectivity with MCG managed by a first network node and a SCG managed by a second network node in a wireless communication network.

According to some embodiments herein, the communication device may receive a Reconfiguration message from the first network node or the second network node (512). The Reconfiguration message comprises information on configuration of a first hop CPC and encapsulated information concerning future CPC hops. The communication device may evaluate execution conditions for CPC candidates based on the content of the Reconfiguration message, and transmit a complete message in response to the Reconfiguration message to the first network node or the second network node. The communication device may evaluate the execution conditions for the first hop CPC candidates, after the execution of the first hop CPC, evaluate the execution conditions for the second hop CPC candidates, and so on for the future CPC hops.

According to some embodiments herein, the communication device may receive a first Reconfiguration message from the first network node. The first Reconfiguration message contains information on a first hop CPC configuration. The communication device may evaluate execution conditions for CPC candidates based on the content of the first Reconfiguration message. The communication device may receive a second Reconfiguration message from the first network node. The second Reconfiguration message comprises information on a second hop CPC configuration. After the execution of the first hop CPC, the communication device may evaluate execution conditions for CPC candidates based on the content of the second Reconfiguration message, and transmit a Reconfiguration Complete message in response to the second Reconfiguration message to the first network node.

According to some embodiments herein, the communication device may receive a first Reconfiguration message from the first network node. The first Reconfiguration message contains information on a first hop CPC configuration. The communication device may receive a second Reconfiguration message from the first network node. The second Reconfiguration message comprises information on a second hop CPC configuration and an indication indicating the CPC configuration is to be applied to the second CPC hop. The communication device may evaluate execution conditions for the first hop CPC candidates based on the content of the first Reconfiguration message. After the execution of the first hop CPC, the communication device may evaluate execution conditions for the second hop CPC candidates based on the content of the second Reconfiguration message and transmit a complete message to the first network node.

Embodiments herein includes different solutions for enabling multi-hop CPC configurations and discusses the implications of these solutions from the perspective of the MN, source SN, T-SNs, and the UE.

Embodiments herein make it possible to support frequent SCG changes without reconfiguring or re-initiating CPC, which can minimize the interruption times perceived by a UE.

Therefore embodiments herein provide an improved method for handling multi-hop CPC configuration for a communication device configured with dual connectivity.

### BRIEF DESCRIPTION OF THE DRAWINGS

Examples of embodiments herein are described in more detail with reference to attached drawings in which:

FIG. 1 is a schematic block diagram illustrating dual connectivity combined with carrier aggregation in MR-DC;

FIG. 2 is a schematic block diagram illustrating E-UTRAN-NR Dual Connectivity;

FIG. 3 is a schematic block diagram illustrating a NR-DC, where both the master node controlling the MCG and the secondary node controlling the SCG are NR;

FIG. 4 is an example signalling sequences for configuration of an inter-SN CPC in 3GPP Rel-17;

FIG. 5 is a schematic block diagram illustrating a wireless communication network;

FIGS. 6 (a), (b) and (c) are examples of the signalling for MN initiated multi-hop CPC configuration, inter-inter SN case;

FIGS. 7 (a) and (b) are examples of the signalling for MN initiated multi-hop CPC configuration, inter-intra SN case;

FIGS. 8 (a), (b) and (c) are examples of the signalling for MN initiated multi-hop CPC configuration, intra-inter SN case;

FIGS. 9 (a) and (b) are examples of the signalling for MN initiated multi-hop CPC configuration, intra-intra SN case;

FIGS. 10 (a), (b) and (c) are examples of the signalling for SN initiated multi-hop CPC configuration, inter-inter SN case;

FIGS. 11 (a) and (b) are examples of the signalling for SN initiated multi-hop CPC configuration, inter-intra SN case;

FIGS. 12 (a), (b) and (c) are examples of the signalling for SN initiated multi-hop CPC configuration, intra-inter SN case;

FIGS. 13 (a) and (b) are examples of the signalling for SN initiated multi-hop CPC configuration, intra-intra SN case with MN involvement;

FIG. 14 is an example of the signalling for SN initiated multi-hop CPC configuration, intra-intra SN case without MN involvement;

FIGS. 15 (a), (b) and (c) are examples of the signalling for MN-SN initiated multi-hop CPC configuration, inter-inter SN case;

FIGS. 16 (a) and (b) are examples of the signalling for MN-SN initiated multi-hop CPC configuration, inter-intra SN case;

FIGS. 17(a), (b) and (c) are examples of the signalling for MN-SN initiated multi-hop CPC configuration, intra-inter SN case;

FIGS. 18 (a) and (b) are examples of the RRC Reconfiguration message in the case of the CPC within CPC multi-hop configuration;

FIG. 19 is a flow chart illustrating a method performed in a first network node according to embodiments herein;

FIG. 20 is a flow chart illustrating a method performed in a second network node according to embodiments herein;

FIG. 21 is a flow chart illustrating a method performed in a first target candidate secondary node according to embodiments herein;

FIG. 22 is a flow chart illustrating a first method performed in a communication device according to embodiments herein;

FIG. 23 is a flow chart illustrating a second method performed in a communication device according to embodiments herein;

FIG. 24 is a flow chart illustrating a third method performed in a communication device according to embodiments herein;

FIG. 25 is a schematic block diagram illustrating an example embodiment of a network node; and

FIG. 26 is a schematic block diagram illustrating an example embodiment of a communication device.

### DETAILED DESCRIPTION

Embodiments herein refer to a first network node operating as a Master Node (MN), e.g. having a Master Cell Group (MCG) configured to a UE; that MN may be a gNodeB, or a Central Unit gNodeB (CU-gNB) or an eNodeB, or a Central Unit eNodeB (CU-eNB), or any network node and/or network function.

Embodiments herein also refer to a second network node operating as a Secondary Node (SN), or Source Secondary Node (S-SN) e.g. having a Secondary Cell Group (SCG) pre-configured to, i.e. not connected to, a UE; that SN may be a gNodeB, or a Central Unit gNodeB (CU-gNB) or an eNodeB, or a Central Unit eNodeB (CU-eNB), or any network node and/or network function. Notice that MN, S-SN and T-SN may be from the same or different Radio Access Technologies, and possibly be associated to different Core Network nodes.

The description often refers to a “Secondary Node (SN)”, or target SN. This is equivalent to say this is a target candidate SN, or a network node associated to a target candidate PSCell that is being configured. If a UE would connect to that cell, transmissions and receptions with the UE would be handled by that node if the cell is associated to that node.

The description says that a cell resides in a node e.g., a target candidate cell resides in the S-SN or the T-SN. That is equivalent to say that a cell is managed by the node, or is associated to the node, or associated with the node, or that the cell belongs to the node, or that the cell is of the node.

“MN-initiated CPC” corresponds to a procedure wherein the MN for a UE configured with MR-DC determines to configure CPC. The MN provides the candidate cells recommended by MN via the latest measurement results for the SN to choose and configure the SCG cell(s), and provides the upper limit for the number of PSCells. Within the list of cells as indicated within the measurement results indicated by the MN, the SN decides the list of PSCell(s) to prepare and, for each prepared PSCell, the SN decides other SCG SCells and provides the new corresponding SCG radio resource configuration to the MN in an NR RRC configuration message e.g. RRCReconfiguration, contained in the SgNB Addition Request Acknowledge message with the prepared PSCell ID(s). If forwarding is needed, the target SN provides forwarding addresses to the MN. The target SN includes the indication of the full or delta RRC configuration. The target SN can either accept or reject each of the candidate cells suggested by the MN, i.e. it cannot come up with any alternative candidates.

“SN-initiated CPC” corresponds to a procedure wherein the Source SN for a UE configured with MR-DC determines to configure CPC. Upon determining the Source SN selects e.g. based on reported measurements, one or more target candidate cells e.g. target candidate PSCell(s), wherein at least one cell is associated to the Source SN, and at least another cell is associated to a neighbour SN. It can be said that if all target candidate cells are associated to the Source SN that is an “SN-initiated intra-SN CPC”, which may be referred as the Release 16 solution. It can be said that if at least one target candidate cell is associated to the a neighbour SN that is an “SN-initiated inter-SN CPC”, which may be referred as a Release 17 solution.

The description refers to a candidate SN, or SN candidate, or an SN, as the network node, e.g. gNodeB, that is prepared during the CPA procedure and that can create an RRC Reconfiguration message with an SCG configuration, e.g. RRCReconfiguration**, to be provided to a UE and stored, with an execution condition, wherein the UE only applies the message upon the fulfilment of the execution condition. That candidate SN is associated to one or multiple PSCell candidate cell(s) that the UE can be configured with. The UE then can execute the condition and accesses one of these candidate cells, associated to a candidate SN that becomes the SN or simply the SN after execution, i.e. upon fulfilment of the execution condition.

Embodiments herein refer to a neighbour SN and a Source SN as different entities, though both could be a target candidate SN for CPC.

Embodiments herein refer to the subsequent CPC configurations as the next hop CPC configurations. In particular, the CPC defined in Rel-17 is referred to as the “first hop” CPC and each subsequent CPC is referred to as the “next hop” CPC.

The configuration of CPC can be done using the same information elements (IEs) as conditional handover, which may be called at some point conditional configuration or conditional reconfiguration. The principle for the configuration is the same with configuring triggering/execution condition(s) and a reconfiguration message to be applied when the triggering condition(s) are fulfilled. The configuration IEs from TS 38.331:

### ConditionalReconfiguration

The IE ConditionalReconfiguration is used to add, modify and release the configuration of conditional configuration.

ConditionalReconfiguration information element

-- ASN1START
-- TAG-CONDITIONALRECONFIGURATION-START

| ConditionalReconfiguration-r16 ::= | SEQUENCE { | |
|---|---|---|
| attemptCcondReconfig-r16 | ENUMERATED {true} | OPTIONAL, |

-- Need N

| | | |
|---|---|---|
| condConfigToRemoveList-r16 | CondConfigToRemoveList-r16 | OPTIONAL, |

-- Need N

| | | |
|---|---|---|
| condConfigToAddModList-r16 | CondConfigToAddModList-r16 | OPTIONAL, |

-- Need N
...
}

| | |
|---|---|
| CondConfigToRemoveList-r16 ::= | SEQUENCE (SIZE (1.. maxNrofCondCells)) OF |

CondConfigId-r16
-- TAG-CONDITIONALRECONFIGURATION-STOP
-- ASN1STOP

ConditionalReconfiguration field descriptions

condConfigToAddModList
List of the configuration of candidate SpCells to be added or modified for CHO or CPC.
condConfigToRemoveList
List of the configuration of candidate SpCells to be removed. When the network removes
the stored conditional configuration for a candidate cell, the network releases the measIDs
associated to the condExecutionCond if it is not used by the condExecutionCond of other
candidate cells.
- CondConfigId
The IE CondConfigId is used to identify a CHO or CPC configuration.

CondConfigId information element

-- ASN1START
-- TAG-CONDCONFIGID-START
CondConfigId-r16 ::= INTEGER(1.. maxNrofCond-Cells)
-- TAG-CONDCONFIGID-STOP
-- ASN1STOP
- CondConfigToAddModList
The IE CHO-ConfigToAddModList concerns a list of conditional configurations to add or
modify, with for each entry the cho-ConfigId and the associated condExecutionCond and
condRRCReconfig.

CondConfigToAddModList information element

-- ASN1START
-- TAG-CONDCONFIGTOADDMODLIST-START

| | |
|---|---|
| CondConfigToAddModList-r16 ::= | SEQUENCE (SIZE (1.. maxNrofCondCells)) OF |

CondConfigToAddMod-r16
CondConfigToAddMod-r16 ::= SEQUENCE {

| | |
|---|---|
| condConfigId-r16 | CondConfigId-r16, |
| condExecutionCond-r16 | SEQUENCE (SIZE (1..2)) OF MeasId |

OPTIONAL, -- Need S

| | |
|---|---|
| condRRCReconfig-r16 | OCTET STRING (CONTAINING |

RRCReconfiguration) OPTIONAL, -- Need S
...
}
-- TAG-CONDCONFIGTOADDMODLIST-STOP
-- ASN1STOP

CondConfigToAddMod field descriptions

condExecutionCond
The execution condition that needs to be fulfilled
in order to trigger the execution of a conditional configuration.
The field is mandatory present when a condConfigId is being
added. Otherwise, when the condRRCReconfig associated
to a condConfigId is being modified it is optionally present
and the UE uses the stored value if the field is absent.
condRRCReconfig
The RRCReconfiguration message to be applied
when the condition(s) are fulfilled. The field is
mandatory present when a condConfigId is being added.
Otherwise, when the condExecutionCond associated to a
condConfigId is being modified it is optionally present
and the UE uses the stored value if the field is absent.

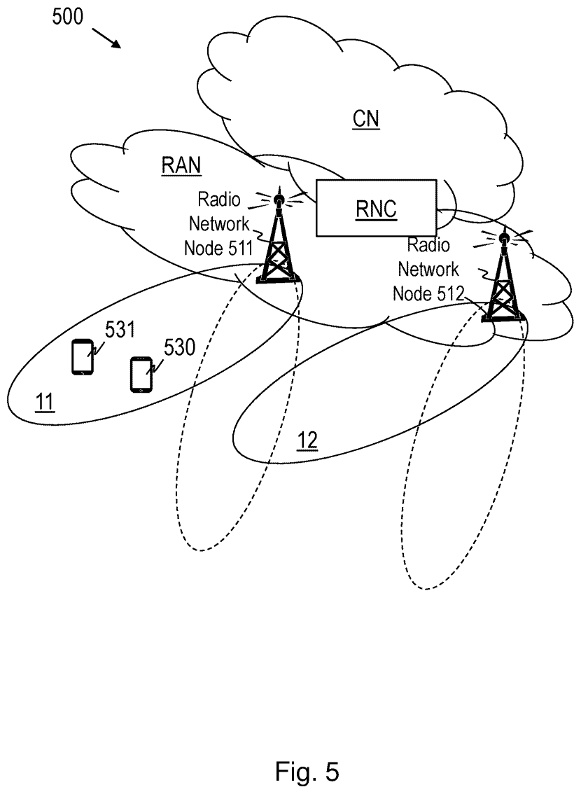

Embodiments herein relate to communications networks in general. FIG. 5 is a schematic overview depicting a communication network 500. The communication network 500 may be a wireless communications network comprising one or more RANs, and one or more CNs. The communication network 500 may use a number of different technologies, such as Wi-Fi, Long Term Evolution (LTE), LTE-Advanced, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

In the wireless communication network 500, one or more wireless communication devices 530, 531 such as a UE, a mobile station or a wireless terminals communicates via one or more Radio Access Networks (RAN) to one or more core networks (CN). It should be understood by the skilled in the art that “wireless communication device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

Network nodes operate in the wireless communication network 500 such as a first network node 511 and a second network node 512. The first and second network node 511, 512 may be any of RAN node, such as gNB, eNB, en-gNB, ng-eNB, gNB etc. The first network node 511 provides radio coverage over a geographical area, a service area 11, which may also be referred to as a beam or a beam group where the group of beams is covering the service area of a first radio access technology (RAT), such as 5G, LTE, Wi-Fi or similar. The second network node 512 provides radio coverage over a geographical area, a service area 12, which may also be referred to as a beam or a beam group where the group of beams is covering the service area of a first or a second radio access technology (RAT), such as 5G, LTE, Wi-Fi or similar. It should be noted that a network node may be a RAN node, a CN node or an OAM node.

The first and second network nodes 511 and 512 may be a transmission and reception point e.g. a radio access network node such as a Wireless Local Area Network (WLAN) access point or an Access Point Station (AP STA), an access controller, a base station, e.g. a radio base station such as a NodeB, a gNB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless communication device within the service area served by the respective first and second network nodes 511 and 512 depending e.g. on the radio access technology and terminology used. The first and second network nodes 511 and 512 may be referred to as a source and target network node, respectively, and may communicate with the wireless communication device 530, 531 with Downlink (DL) transmissions to the wireless communication device 530, 531 and Uplink (UL) transmissions from the wireless communication device 530, 531.

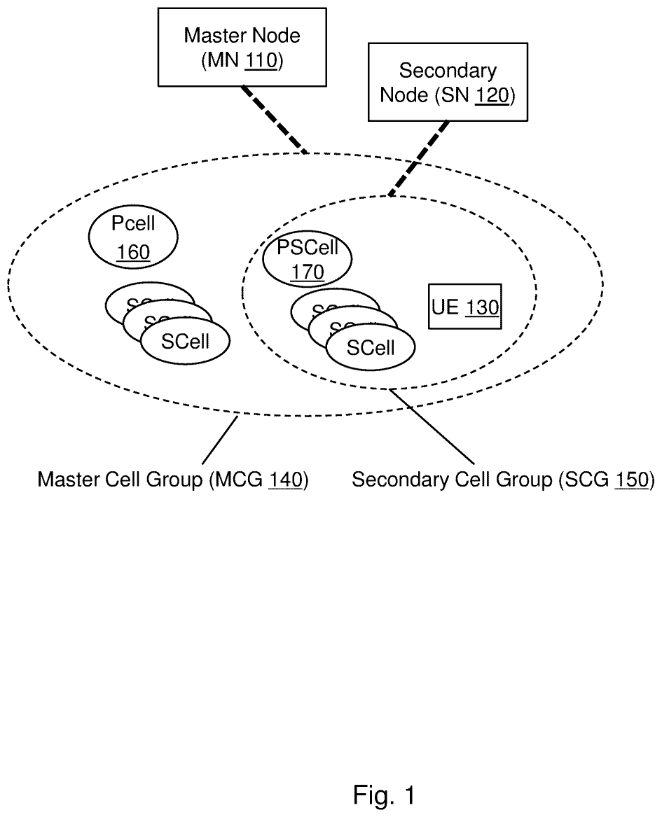

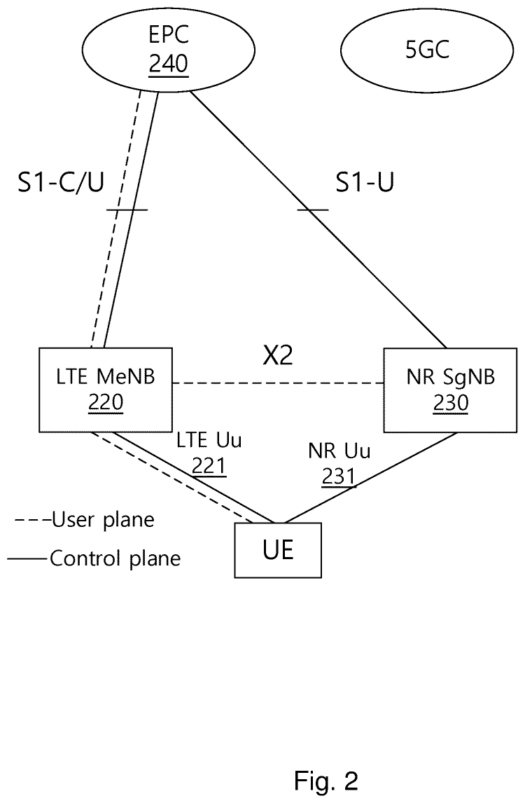

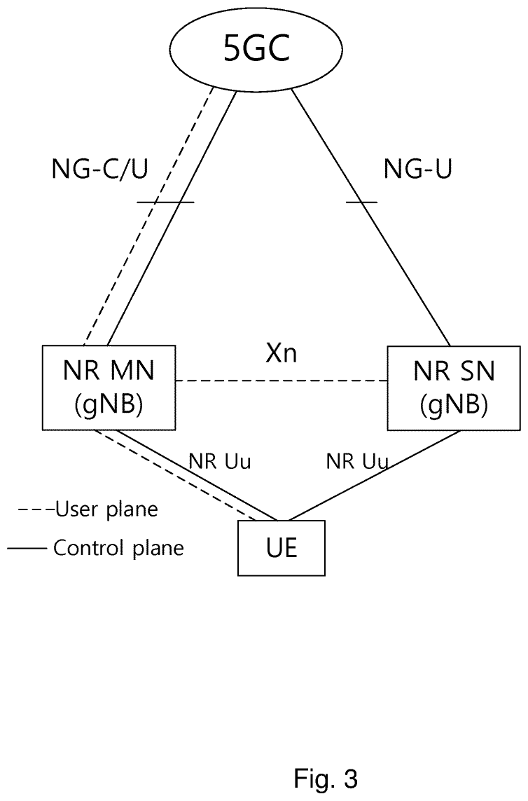

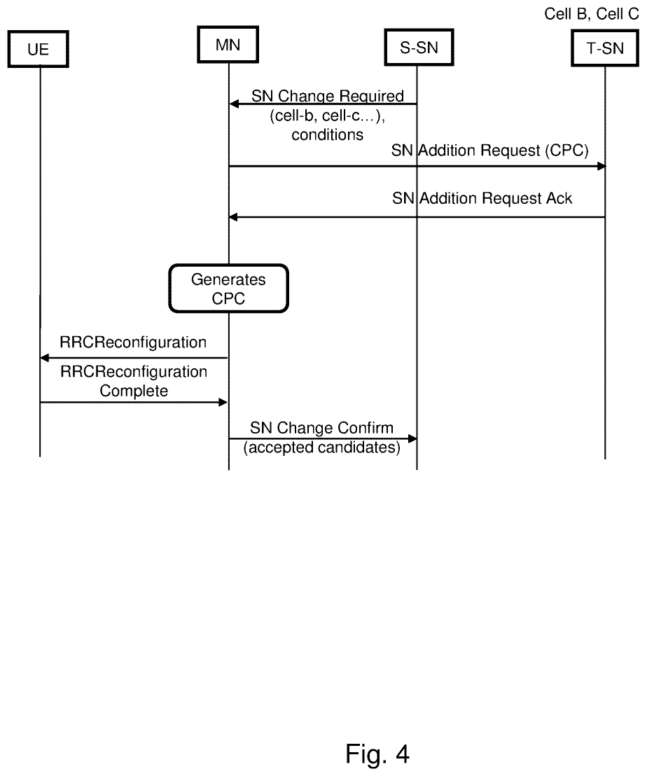

The first and second network nodes 511, 512 may each be either a master node (MN) having a cell group MCG, or a secondary node (SN) having a cell group SCG, respectively, as shown in FIG. 1.

The description herein describes terms like SCG and PSCell, as one of the cells associated with the SCG. That can be for example a PSCell as defined in NR specifications e.g. RRC TS 38.331, defined as a Special Cell (SpCell) of the SCG, or a Primary SCG Cell (PSCell), as follows:
Secondary Cell Group: For a UE configured with dual connectivity, the subset of serving cells comprising of the PSCell and zero or more secondary cells (SCells).
Special Cell: For Dual Connectivity operation the term Special Cell refers to the PCell of the MCG or the PSCell of the SCG, otherwise the term Special Cell refers to the PCell.
Primary SCG Cell (PSCell): For dual connectivity operation, the SCG cell in which a UE performs random access when performing the Reconfiguration with Sync procedure.

Embodiments herein comprises different methods for the network to configure multi-hop CPC. These methods differ in the sequence of messages exchanged between MN, S-SN, T-SNs and UE, and in the way the multi-hop CPC configuration is communicated to the UE, e.g., CPC within CPC or separate reconfiguration messages. The description describes the solution aspects from the perspective of the MN, S-SN, T-SNs and UE, as discussed in the following.

There are different variants of the multi-hop CPC configurations depending on whether the CPC hops are inter or intra and whether they are MN or SN initiated:
a) In the first embodiment, multi-hop CPC configuration is MN-initiated. There are different cases within this embodiment depending on the type, i.e. inter or intra, of the first and subsequent CPC configurations:
i. Inter-inter configuration, where each next hop CPC configuration is an inter CPC configuration.
ii. Inter-intra configuration, where the “first hop” is an inter CPC configuration and the next hop is an intra CPC configuration.
iii. Intra-inter configuration, where the “first hop” is an intra CPC configuration and the next hop is an inter CPC configuration.
iv. Intra-intra configuration, where the “first hop” is an intra CPC configuration and the next hop is also an intra CPC configuration.
b) In the second embodiment, multi-hop CPC configuration is SN-initiated, i.e., each SN, in the first hop S-SN and in each next hop T-SN, decides whether or not to initiate the configuration for the next hop CPC. There are different cases within this embodiment depending on the type, i.e. inter or intra, of the first and subsequent CPC configurations:
i. Inter-inter configuration, where each next hop CPC configuration is an inter CPC configuration.
ii. Inter-intra configuration, where the “first hop” is an inter CPC configuration and the next hop is an intra CPC configuration.
iii. Intra-inter configuration, where the “first hop” is an intra CPC configuration and the next hop is an inter CPC configuration.
iv. Intra-intra configuration, where the “first hop” is an intra CPC configuration and the next hop is also an intra CPC configuration. Here, there are two possible subcases:
   With MN involvement, where the multi-hop CPC configuration is communicated to the UE through the MN.
   Without MN involvement, where the S-SN provides directly the information to the UE about the multi-hop CPC configuration.
c) In the third embodiment, multi-hop CPC configuration is MN-SN initiated, i.e., the first hop CPC is MN initiated and the subsequent hop CPC is SN initiated. There are different cases within this embodiment depending on the type, inter or intra, of the first and subsequent CPC configurations:
i. Inter-inter configuration, where each next hop CPC configuration is an inter CPC configuration.
ii. Inter-intra configuration, where the “first hop” is an inter CPC configuration and the next hop is an intra CPC configuration.
iii. Intra-inter configuration, where the “first hop” is an intra CPC configuration and the next hop is an inter CPC configuration.

### Embodiments and Actions of Master Node

Related to the configuration of the multi-hop CPC, the MN can perform the following actions:
a. Transmit an SN Addition Request for CPC to a target candidate SN, e.g. T-SN 1
i. In one option, this is triggered by the MN itself, i.e. MN-initiated CPC.
ii. In one option, this is triggered by the S-SN, i.e. SN-initiated CPC. That is, S-SN sends an SN Change Required to the MN, requesting CPC, and MN triggers the SN Addition request to the T-SN 1.
b. In response to the SN Addition Request, receive an SN Addition Request Ack from the T-SN 1 including:
i) an indication that this is a multi-hop CPC,
ii) identifier(s) of one or more target candidate PSCells for the second hop CPC configuration,
iii) identifier(s) of one or more Target Candidate SN(s) e.g., T-SN 2, associated to the one or more target candidate PSCells.
c. Trigger an SN Addition procedure for CPC to the one or more Target Candidate SN(s) indicated by the T-SN 1 e.g., T-SN 2, for the one or more target candidate PSCells in the second hop CPC configuration.
d. Trigger an SN Release or SCG deactivation procedure to the one or more Target Candidate SN(s) indicated by the T-SN 1 e.g., T-SN 2, for the one or more target candidate PSCells in the second hop CPC configuration.
e. Transmit an SN Modification Request to the S-SN in the case of the intra-CPC first hop configuration initiated by the MN.
f. Transmit Data Forwarding Address Indication to an SN, e.g. S-SN in the case of the first hop or T-SN in the case of subsequent hops, in the case of the inter-CPC configuration initiated by the MN.
g. Receive an SN Change Required from the S-SN in the case of the inter-CPC first hop configuration initiated by the S-SN.
h. Receive an SN Modification Required from the S-SN in the case of the intra-CPC first hop configuration initiated by the S-SN.

Some example embodiments are listed in the following for MN:

Embodiment 1: A method of triggering of the SN Addition procedure for CPC to the one or more Target Candidate SN(s) e.g. T-SN 2) indicated by the MN or the T-SN 1, for the one or more target candidate PSCells in the second hop, the method comprises:
the MN transmitting an SN Addition Request for CPC to T-SN 2, including an indication indicating this is a second hop CPC;
in response, the MN receives an SN Addition Request Ack including at least one SCG configuration associated to at least one of the one or more target candidate PSCells requested by the MN.

Embodiment 2: The MN may transmit an SN Addition Request for CPC to T-SN 2 after the execution of the current hop CPC towards T-SN 1. In this case, the multi-hop CPC becomes a traditional single-hop CPC, i.e., each CPC is triggered subsequently only upon the execution of the previous CPC.

Embodiment 3: The MN may transmit an SN Addition request for CPC to T-SN 2 before the execution of the current hop CPC towards T-SN 1. In this case, there are different options for the MN to communicate the multi-hop CPC configurations to the UE as a part of the RRC Reconfiguration message:

Option 1: The MN may wait to receive the information about the SCG configurations for the next k hops CPCs before sending the RRC Reconfiguration message to the UE. In this case, the MN sends to the UE the RRC Reconfiguration message that contains CPC within CPC configuration, i.e., the information about the next hop CPC is encapsulated into the information about the previous hop CPC. For example, in the case of two-hop inter CPC, the MN waits to receive an SN Addition Request Ack from the T-SN 2 that includes at least one SCG configuration for the second hop CPC. Upon the reception of such an SN Addition Request Ack, the MN creates the RRC Reconfiguration message that contains the information about both the first hop and the second hop CPC and sends this RRC Reconfiguration message to the UE.

Option 2: The MN may send the first RRC Reconfiguration message to the UE as soon as it has the information about the first hop CPC. The MN may then initiate the configuration of the next hop CPC, e.g., trigger the SN Addition procedure for CPC to the T-SN 2 in the case that the second hop CPC is an inter CPC, and upon receiving the information about the SCG configurations for the next hop CPC, e.g., upon receiving an SN Addition Request Ack from T-SN 2, the MN may:
a) Create a new RRC Reconfiguration message that contains the information about both the first hop, e.g., T-SN 1, and the subsequent hops e.g., T-SN 2, CPC configurations and send this RRC Reconfiguration message to the UE. This RRC Reconfiguration message contains an encapsulated CPC within CPC configuration and has the same structure as the RRC Reconfiguration message described in Option 1.
b) Create a new RRC Reconfiguration message that contains only the information about the next hop, e.g., T-SN 2, CPC configurations and send this RRC Reconfiguration message to the UE. This RRC Reconfiguration message has to contain an indicator that the CPC configuration content concerns the future next hop CPC configuration, i.e., it has to be clear to the UE that the CPC configuration contained in this message is to be applied in the second hop and not in the first hop.
c) Store the information concerning the next hop CPCs, e.g., the CPC configuration information received in the SN Addition Request Ack from T-SN 2, wait for the execution of the first hop CPC and send the RRC Reconfiguration message containing the information concerning the next hop CPC immediately after the execution of the first hop CPC, i.e., immediately after the T-SN 1 becomes the SN in the inter CPC example.

Embodiment 4: determines Embodiment 2 or 3 based on S-SN indication When deciding when and how to communicate the multi-hop CPC configurations to the UE, i.e., which of the above options for creating and sending the RRC Reconfiguration message to choose, the MN should take into consideration the indication sent by the S-SN about whether it is time critical to configure the first hop CPC as soon as possible and how many hops ahead the S-SN prefers to have configured. If, for example, the S-SN indicates that the configuration for the first hop CPC needs to be sent as soon as possible to the UE, the MN may decide to choose one of the solutions indicated under Option 2 for Embodiment 3, which do not delay the communication of the first hop CPC configuration to the UE.

Embodiment 5: The triggering of the SN Release or SCG deactivation procedure to the one or more Target Candidate SN(s), e.g., T-SN 2, indicated by the MN or the T-SN 1. The MN may trigger SN Release procedure due to the MN change (handover); the target MN may trigger SN addition procedure previously described to add CPC hops. The MN may trigger SCG deactivation procedure due to temporarily unavailability of the SCG, e.g., due to overheating.

Embodiment 6: SN Addition Request may include an indication on which hop that is e.g., first, second, third. Based on that indication the candidate SN being requested may decide to accept or not, or if accepted, how to set its timers and when to expect the UE to possibly come.

Embodiment 7: SN Addition Request may include an indication on the maximum number of hops the UE supports; together with previous info, the subsequent candidates may know to which extent it may configure multi-hop. This information can be provided to the network by the UE, e.g., the UE may report a capability indicating the maximum number of hops it supports. Alternatively, the UE may indicate to the network, e.g., via UE assistance information, the number of hops it prefers.

Note: Further MN involvement may depend on the choice of the solution for the multi-hop CPC configuration. For example, if CPC within CPC is configured, i.e., Option 1 under Embodiment 3, as the legacy Rel-17 CPC, the CPC is a conditional reconfiguration part of the MCG configuration i.e., it is generated by the MN; and the actual message to be applied is also generated by the MN and contains an MCG part. Hence, when the MN receives the SCG configuration for a second hop RRCReconfiguration**(hop2), it may generate the RRCReconfiguration*(hop1) including the RRCReconfiguration**(hop2). Then, the MN generates a CPC configuration within the RRCReconfiguration*(hop1) wherein that CPC configuration includes target candidate cell for RRCReconfiguration**(hop2). As all relates to a single MN, if MN changes these are not valid any longer, so they need to be cancelled and/or modified.

### Embodiments and Actions of S-SN

Related to the configuration of the multi-hop CPC, the S-SN may perform the following actions:
a. In the case of the SN-initiated inter-CPC, transmit an SN Change Required for CPC to MN, for T-SN 1 as target candidate, including an indication of allowing multi-hop CPC and the maximum number of allowed hops, e.g., if it is not time critical to configure first hop as soon as possible the SN may allow the configuration of multi-hop CPC.
b. In the case of the SN-initiated intra-CPC, transmit an SN Modification Required for CPC to MN. In the SN Modification Required message, the S-SN includes the configuration for the first hop intra CPC, but it may also include the configuration for the subsequent hops intra CPCs or indicate that it wants to configure the second hop inter CPC, e.g., for T-SN 1 as a target candidate. If the S-SN indicates that it wants to configure the second hop inter CPC, e.g., for T-SN 1 as a target candidate, it can also indicate to the MN whether it allows the next hop configurations, and if it does, what is the maximum number of allowed hops.

Note: “allowing” means that the S-SN is not the node taking the decision to configure multi-hop CPC. The decision is taken by each target candidate SN being requested, but there are different options for configuring the multiple hops:

In one option, the MN assists each target candidate SN to configure a second hop, as shown above.

In another option, each target candidate SN may directly request another candidate to configure CPC.

In yet another option, each target candidate SN may configure its own cells as target candidates in a second hop.

### Embodiments and Actions of a First Target Candidate T-SN 1

Related to the configuration of the multi-hop CPC, the T-SN 1 may perform the following actions:
a. Receive a first SN Addition Request for CPC from the MN
   i. In one option, this is triggered by the MN itself, MN-initiated CPC.
   ii. In one option, this is triggered by the S-SN, SN-initiated CPC, i.e., S-SN sends an SN Change Required to the MN, requesting CPC, and MN triggers the SN Addition request to the T-SN 1.
b. Determine to configure multi-hop CPC, e.g., to a second Target Candidate SN 2 (T-SN 2) in the case of an inter-CPC hop.
c. Respond to the first SN Addition Request for CPC to the MN with an SN Addition Request Ack, including:
i) an indication that this is a multi-hop CPC,
ii) identifier(s) of one or more target candidate PSCells for the second hop CPC configuration,
iii) identifier(s) of one or more Target Candidate SN(s) e.g., T-SN 2, associated to the one or more target candidate PSCells.
d. Receive a message from the MN that confirms the successful completion of the second hop CPC configuration, e.g., a message similar to the SN Change confirm in the case of the inter CPC.

### Embodiments and Actions of UE

Related to the configuration of the multi-hop CPC, the UE can perform the following actions:
a. Receive an RRC Reconfiguration message, where the following cases can be distinguished:
i. The UE may receive the RRC Reconfiguration message that contains the information concerning the configuration for the first hop CPC and also the encapsulated information concerning the future hops ahead, i.e., CPC within CPC configuration. In case that prior to the reception of the CPC within CPC configuration the UE received the configuration that contained the information concerning the first hop CPC only, the UE should ‘rewrite’ this prior message and apply the most recent first hop CPC configuration indicated in the RRC Reconfiguration message that contains CPC within CPC configuration.
ii. The UE may receive the RRC Reconfiguration message for each hop separately. For example, the UE may first receive the RRC Reconfiguration message that contains the information concerning the first hop CPC configuration only. Subsequently, the UE may receive the RRC Reconfiguration message that contains the information concerning the second hop CPC configuration only:

In one option, the UE may receive the RRC Reconfiguration message for the second hop before the execution conditions were fulfilled for the first hop. In this case, the RRC Reconfiguration message for the second hop should contain a clear indication that the received CPC configuration is not to be applied in the first hop, but in the second hop.

In another option, the UE may receive the RRC Reconfiguration message for the second hop immediately after applying the CPC configuration for the first hop CPC, e.g., immediately after the T-SN 1 becomes S-SN in the case of inter CPC, in which case the RRC Reconfiguration message for the second hop does not have to contain the indication about the hop number in which the configuration is meant to be applied.
b. Evaluate the execution conditions for the CPC candidates in the order specified by the content of the RRC Reconfiguration message(s), i.e., evaluating the execution conditions for the first hop candidates first, then after the execution of the first hop CPC for the second hop candidates and so on). For example, when the CPC within CPC configuration is received, the UE only performs the evaluation of the execution conditions for the conditional reconfiguration of the “first hop”. That is, the CPC configuration of the “second hop” is stored, but no evaluation of the execution conditions is performed.
c. Transmit a RRC Reconfiguration Complete message as a response to the RRC Reconfiguration message sent by the MN or by the S-SN in the case of the SN initiated intra-intra multi hop CPC configuration without MN involvement.

Multi-hop CPC solutions are meant to support multiple hops ahead CPC configurations. However, it is important to note that each next hop configuration may be less likely to happen than the previous one unless the mobility route of a UE is known in advance to the network. An example of a scenario in which the mobility route of a UE is a priori known to the network is a train mobility, i.e., a UE in a train that is moving in the direction known to the network.

The embodiments herein also enable the option where a first conditional reconfiguration may be a conditional handover (CHO) and subsequent conditional reconfigurations may comprise one or multiple hops of CPC configurations.

In the following, example signaling for different solutions for multi-hop CPC configuration will be illustrated and described.

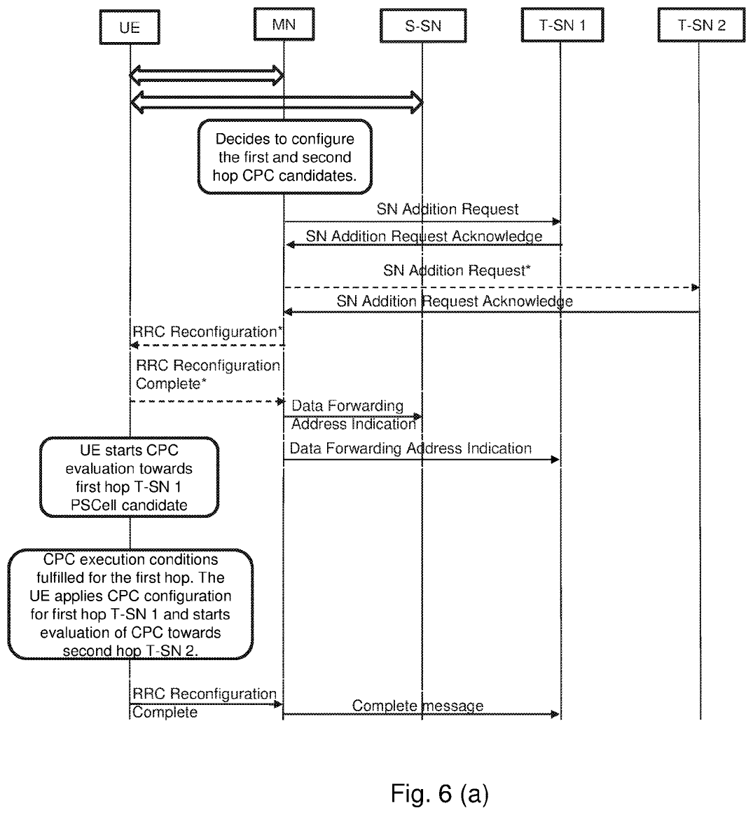

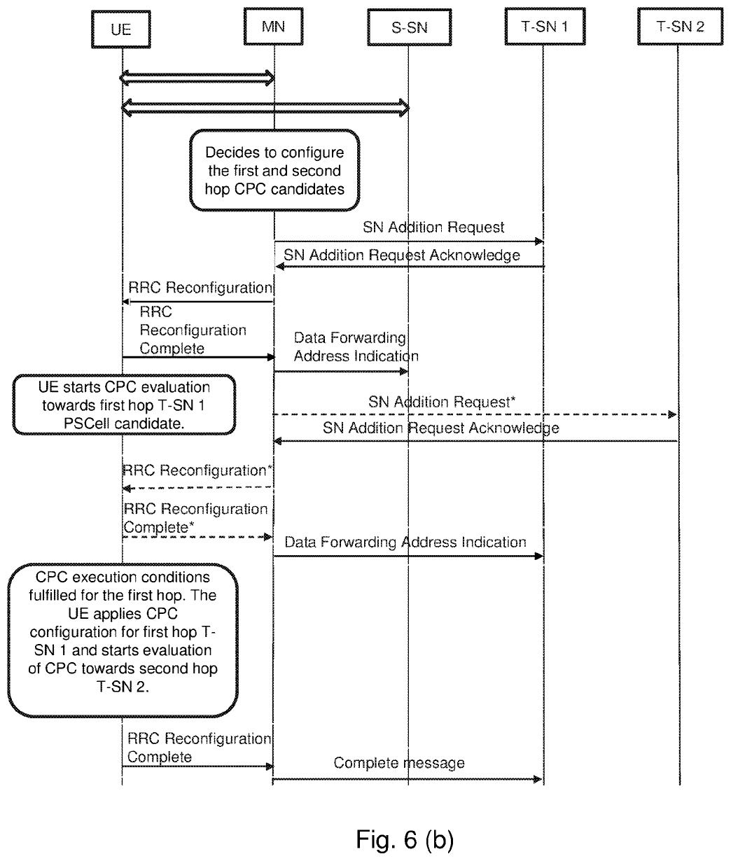

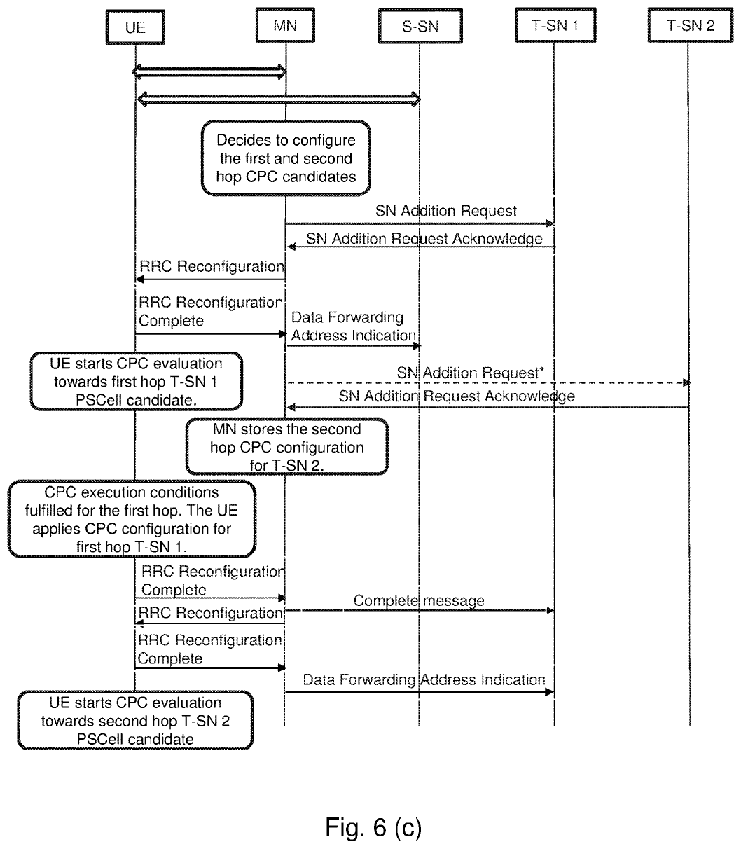

FIGS. 6 (a), (b), (c) show examples of the signalling for MN initiated multi-hop CPC configuration, inter-inter SN case, where (a) is CPC within CPC, (b) is second hop CPC before the execution of the first hop CPC and (c) is second hop CPC just after the execution of the first hop CPC.

New and/or Modified Messages:
SN Addition Request* (c.f., FIGS. 6 (a), (b), and (c)) is modified such that it is clear that T-SN2 is the “second hop” CPC candidate.

This may e.g. be done by adding a new IE for a container CG-ConfigInfo in S-NODE ADDITION REQUEST, where the new container comprises the target candidate configuration of the first CPC configuration which T-SN1 created.

Another option is adding an indication indicating that the request is for a “second hop” CPC candidate. The configuration to be used by T-SN2 when creating the target candidate configuration may be included in existing CG-ConfigInfo or in a new IE for a new container.
RRC Reconfiguration* and RRC Reconfiguration Complete* in FIG. 6 (a) are extended such that they contain the encapsulated information about first and second hop CPC i.e., the information about CPC within CPC.
RRC Reconfiguration* and RRC Reconfiguration Complete* in FIG. 6 (b) can be modified in two different ways:
Option 1: such that they contain the information about the encapsulated first and second hop CPCs, i.e., the information about CPC within CPC,
Option 2: such that they contain the information about the second hop CPC in a way that it is clear that the information concerns the future CPC that should be applied in the second hop and not in the first hop.

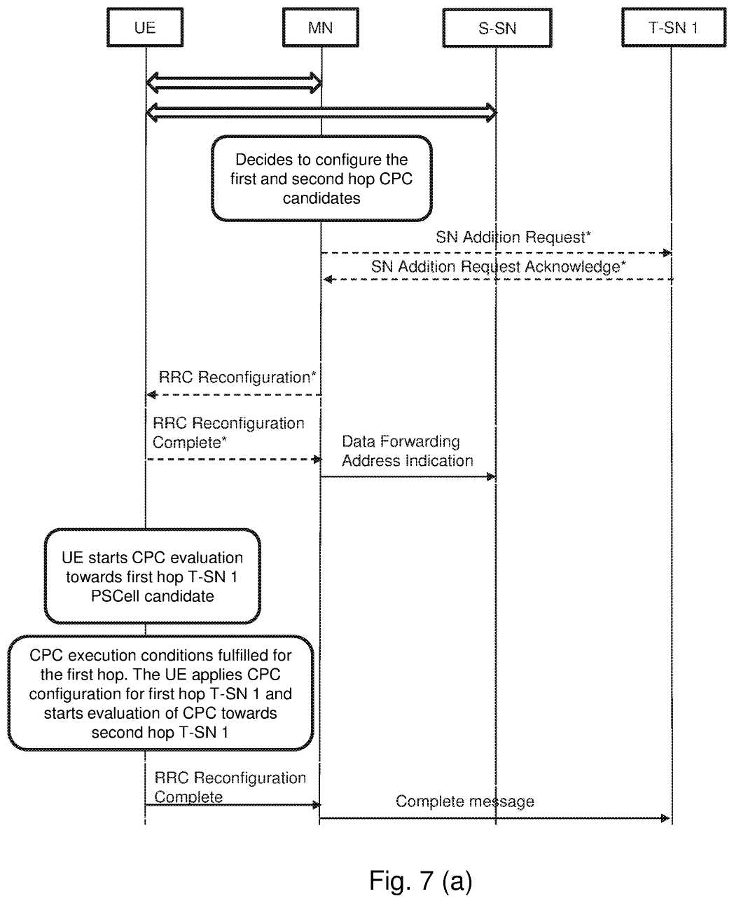

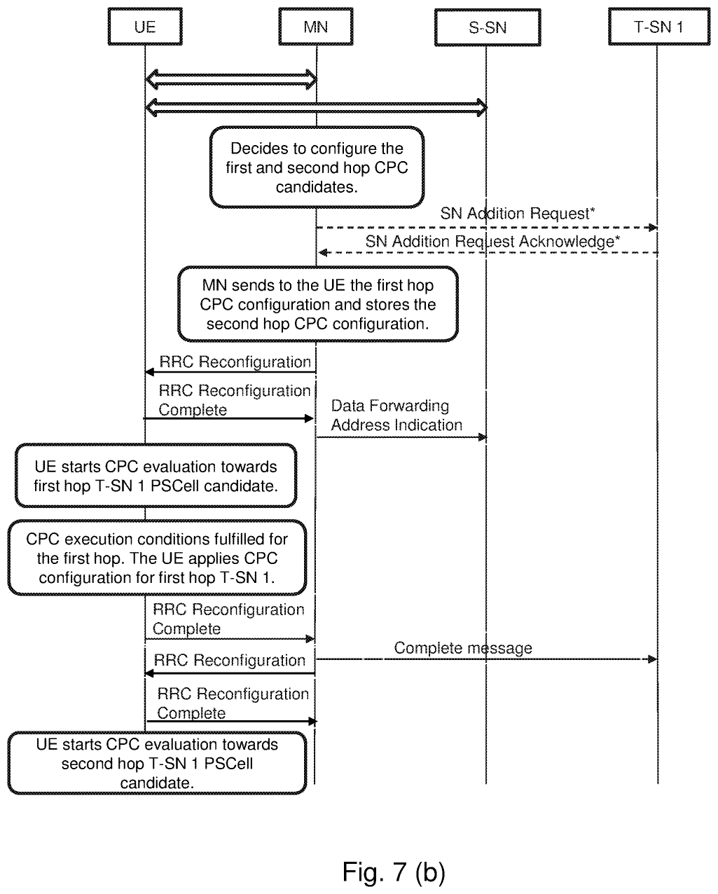

FIG. 7 (a) (b) show examples of the signalling for MN initiated multi-hop CPC configuration, inter-intra SN case, where (a) is CPC within CPC, (b) is second hop CPC just after the execution of the first hop CPC.

New and/or Modified Messages:
SN Addition Request* (c.f., FIGS. 7 (a) and (b)) is extended such that it contains the information about both an inter “first hop” CPC and the subsequent intra “second hop” CPC.

This may e.g. be done by adding a new IE for a container CG-ConfigInfo in S-NODE ADDITION REQUEST, where the new container comprises the target candidate configuration of the first CPC configuration which T-SN1 created.

Another option is adding an indication indicating that the request is for a “second hop” CPC candidate. The configuration to be used by T-SN1 in the second hop when creating the target candidate configuration may be included in existing CG-ConfigInfo or in a new IE for a new container.
SN Addition Request Acknowledge* is extended such that it contains the configuration information about both the “first hop” CPC and the subsequent “second hop” CPC.

This may e.g. be done by adding a new IE for a container CG-Config or CG-CandidateList in S-NODE ADDITION REQUEST, where the new container comprises the target candidate configuration of the first CPC configuration which T-SN1 created.

Another option is adding an indication indicating that the request is for a “second hop” CPC candidate. The configuration to be used by T-SN1 in the second hop when creating the target candidate configuration may be included in existing CG-Config or CG-CandidateList or in a new IE for a new container.

The request for additional cells as CPC candidates may also be used for proposing CPC candidates on the same “hop level” as the other candidates configured by T-SN1.
RRC Reconfiguration* and RRC Reconfiguration Complete* in FIG. 7 (a) are extended such that they contain the encapsulated information about first and second hop CPC, i.e., the information about CPC within CPC.

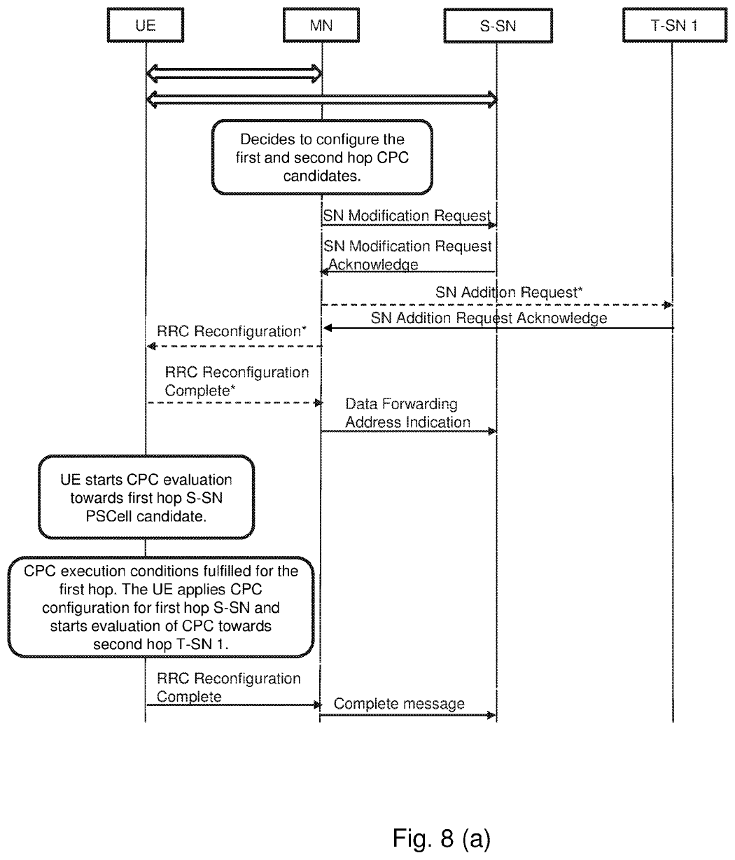

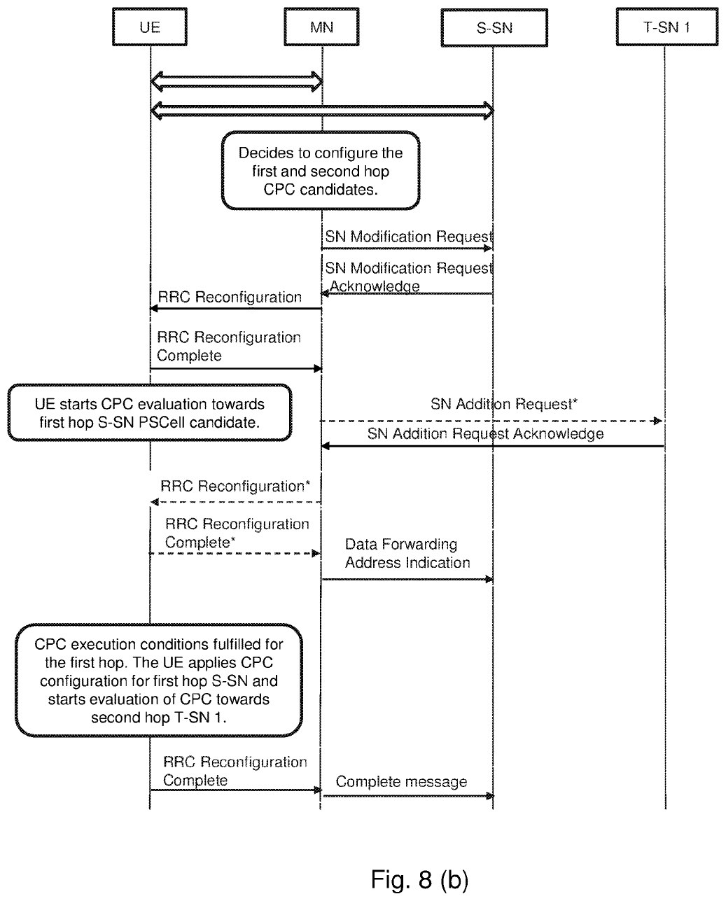

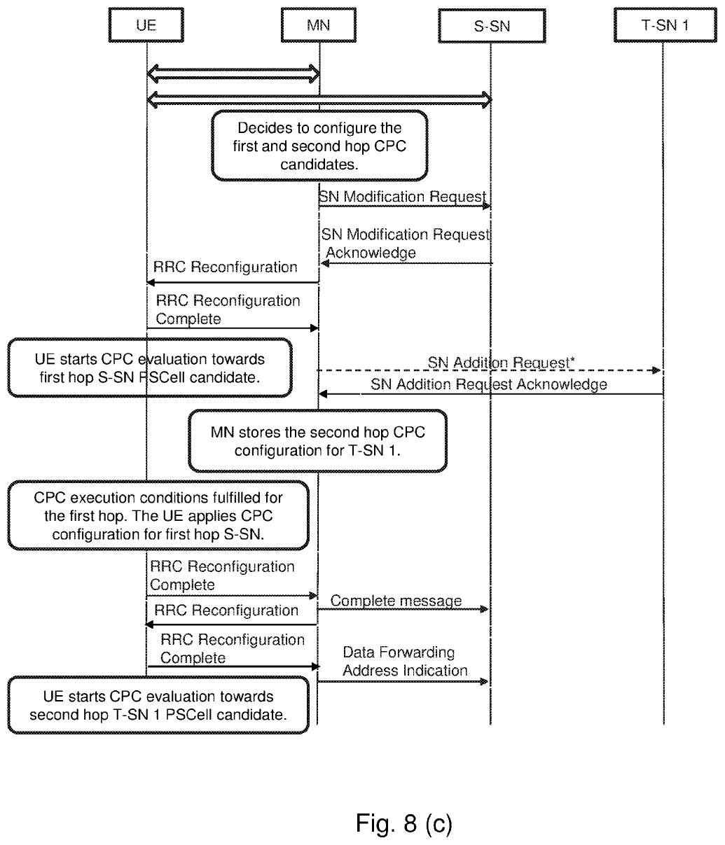

FIGS. 8 (a), (b), (c) show examples of the signalling for MN initiated multi-hop CPC configuration, intra-inter SN case, where (a) is CPC within CPC, (b) is second hop CPC before the execution of the first hop CPC and (c) is second hop CPC just after the execution of the first hop CPC.

New and/or Modified Messages:
SN Addition Request* (c.f., FIGS. 8 (a), (b), and (c)) is modified such that it is clear that T-SN 1 is the “second hop” CPC candidate.

This may e.g. be done by adding a new IE for a container CG-ConfigInfo in S-NODE ADDITION REQUEST, where the new container comprises the target candidate configuration of the second CPC configuration which T-SN1 created.

Another option is adding an indication indicating that the request is for a “second hop” CPC candidate. The configuration to be used by T-SN1 in the second hop when creating the target candidate configuration may be included in existing CG-ConfigInfo or in a new IE for a new container.
RRC Reconfiguration* and RRC Reconfiguration Complete* in FIG. 8 (a) are extended such that they contain the encapsulated information about first and second hop CPC, i.e., the information about CPC within CPC.
RRC Reconfiguration* and RRC Reconfiguration Complete* in FIG. 8 (b) can be modified in two different ways:
Option 1: such that they contain the information about the encapsulated first and second hop CPCs, i.e., the information about CPC within CPC,
Option 2: such that they contain the information about the second hop CPC in a way that it is clear that the information concerns the future CPC that should be applied in the second hop and not in the first hop.

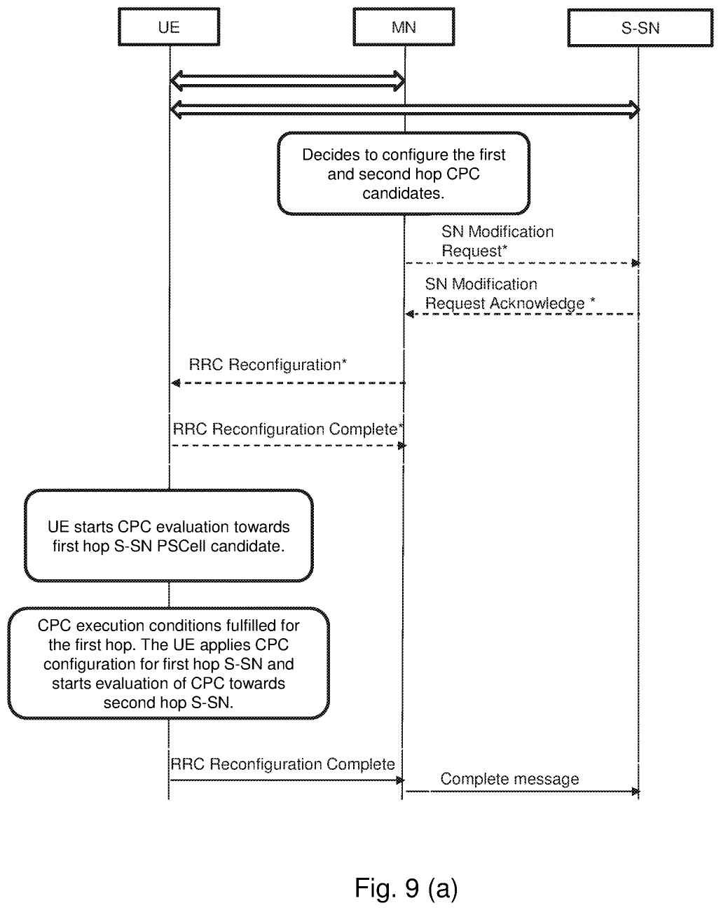

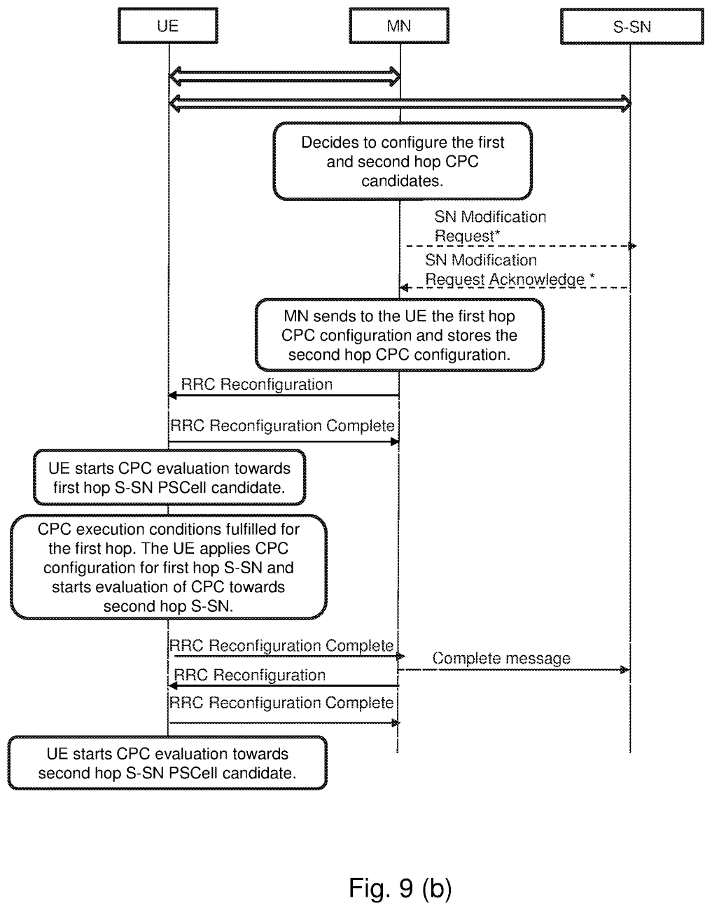

FIGS. 9 (a), (b) show examples of the signalling for MN initiated multi-hop CPC configuration, intra-intra SN case, where (a) is CPC within CPC, (b) is second hop CPC just after the execution of the first hop CPC.

New and/or Modified Messages:
SN Addition Request* (c.f., FIGS. 9 (a) and (b)) is extended such that it contains the information about both an intra “first hop” CPC and the subsequent intra “second hop” CPC.

This may e.g. be done by adding a new IE for a container CG-ConfigInfo in S-NODE ADDITION REQUEST, where the new container comprises the target candidate configuration of the second CPC configuration which S-SN created.

Another option is adding an indication indicating that the request is for a “second hop” CPC candidate. The configuration to be used by S-SN in the second hop when creating the target candidate configuration may be included in existing CG-ConfigInfo or in a new IE for a new container.
SN Addition Request Acknowledge* is extended such that it contains the configuration information about both the “first hop” CPC and the subsequent “second hop” CPC.

This may e.g. be done by adding a new IE for a container CG-Config or CG-CandidateList in S-NODE ADDITION REQUEST, where the new container comprises the target candidate configuration of the first CPC configuration which S-SN created.

Another option is adding an indication indicating that the request is for a “second hop” CPC candidate. The configuration to be used by S-SN in the second hop when creating the target candidate configuration may be included in existing CG-Config or CG-CandidateList or in a new IE for a new container.

The request for additional cells as CPC candidates may also be used for proposing CPC candidates on the same “hop level” as the other candidates configured by S-SN.
RRC Reconfiguration* and RRC Reconfiguration Complete* in FIG. 9 (a) are extended such that they contain the information about multiple CPC configuration hops, i.e., the information about CPC within CPC.

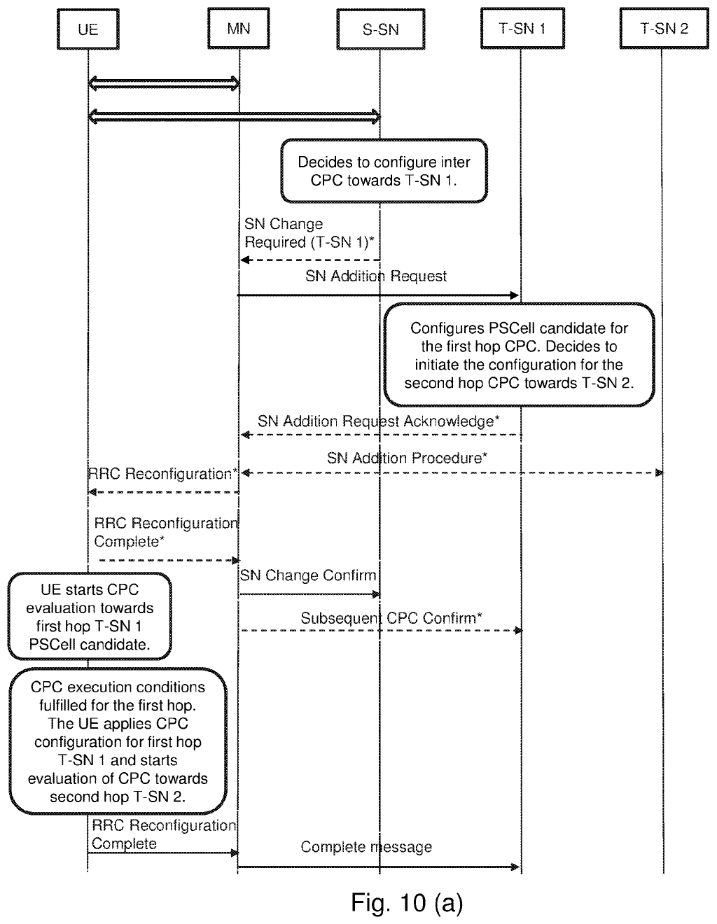

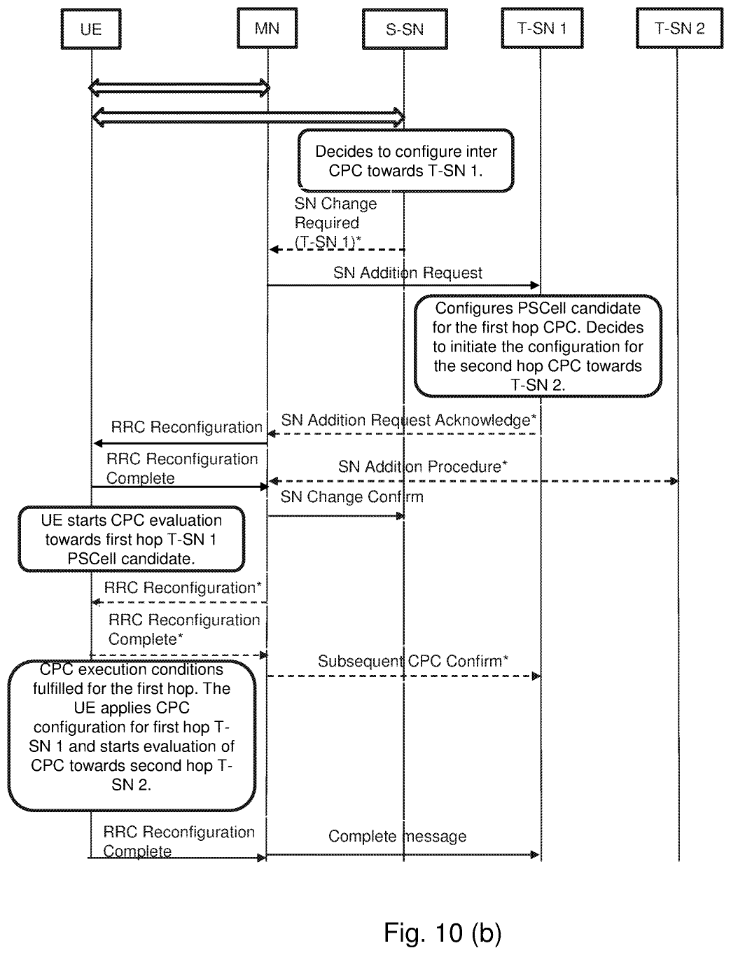

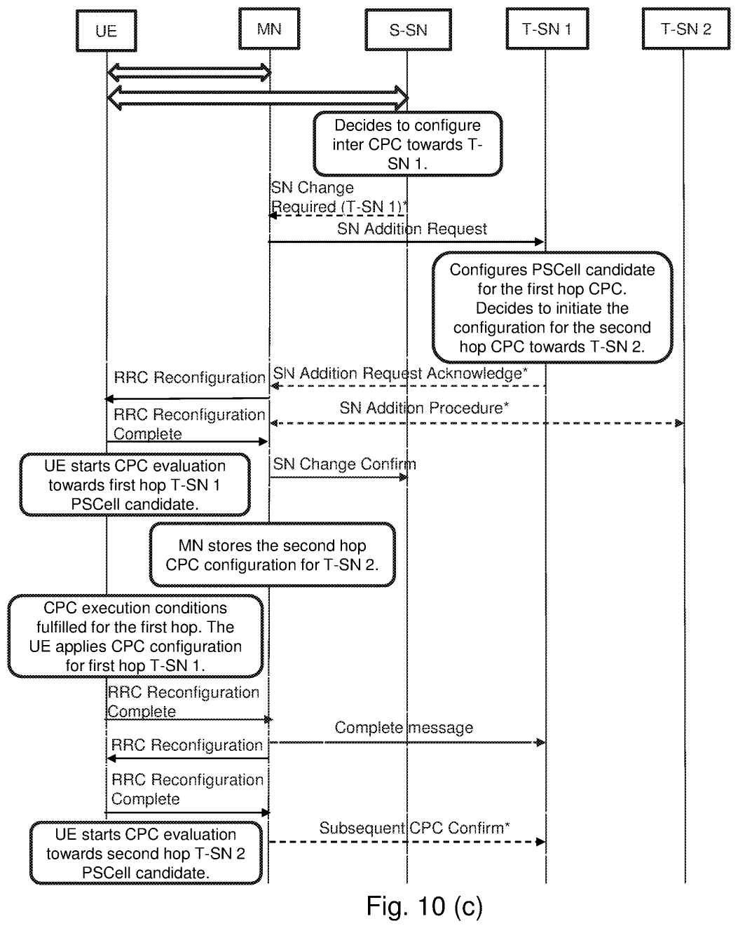

FIGS. 10 (a), (b), (c) show examples of the signalling for SN initiated multi-hop CPC configuration, inter-inter SN case, where (a) is CPC within CPC, (b) is second hop CPC before the execution of the first hop CPC and (c) is second hop CPC just after the execution of the first hop CPC.

New and/or Modified Messages:
SN Change Required (T-SN 1)* (c.f., FIGS. 10 (a), (b), and (c)) is extended such that it contains the indication whether the configuration of the multiple CPC hops is allowed and if yes, what is the maximum number of allowed hops.
SN Addition Request Acknowledge* (c.f., FIGS. 10 (a), (b), and (c)) is extended such that it also contains an inter subsequent CPC initiation indication for T-SN 2 (i.e., it contains the information similar to the SN Change Request message).
SN Addition procedure* (c.f., FIGS. 10 (a), (b) and (c)) is modified such that it is clear that T-SN 2 is the “second hop” CPC candidate.
Subsequent CPC Confirm* (c.f., FIGS. 10 (a), (b) and (c)) is an answer to the SN Change request sent by the T-SN 1 in SN Addition Request Acknowledge* message (e.g., similar to the SN Change Confirm).
RRC Reconfiguration* and RRC Reconfiguration Complete* in FIG. 10 (a) are extended such that they contain the information about multiple CPC configuration hops (i.e., the information about CPC within CPC).
RRC Reconfiguration* and RRC Reconfiguration Complete* in FIG. 10 (b) can be modified in two different ways:
Option 1: such that they contain the information about the encapsulated first and second hop CPCs (i.e., the information about CPC within CPC),
Option 2: such that they contain the information about the second hop CPC in a way that it is clear that the information concerns the future CPC that should be applied in the second hop and not in the first hop.

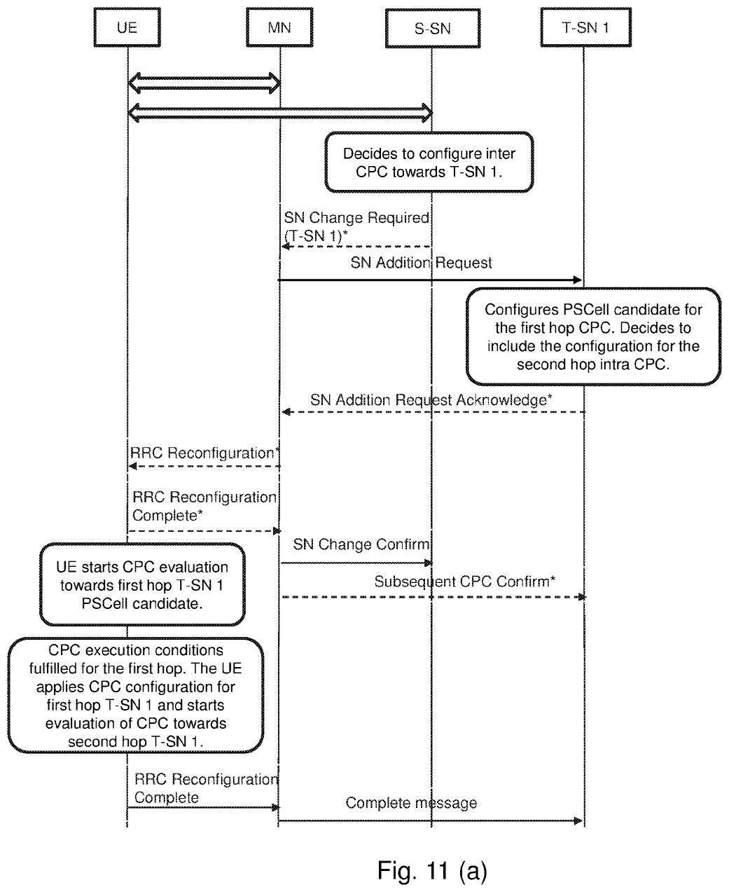

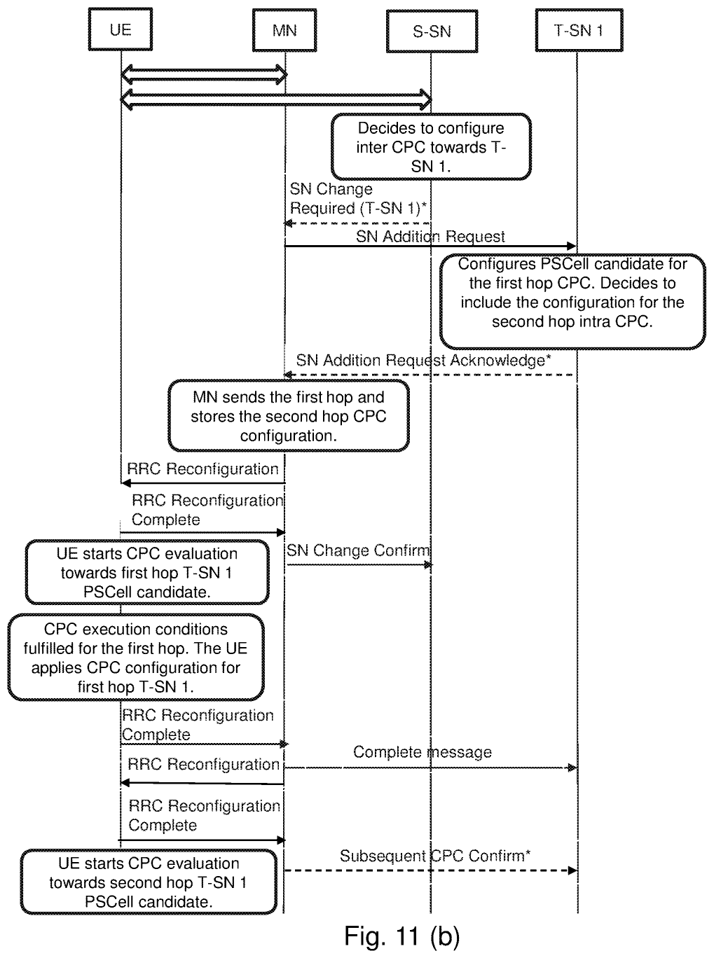

FIG. 11 (a), (b) show examples of the signalling for SN initiated multi-hop CPC configuration, inter-intra SN case, where (a) is CPC within CPC, (b) is second hop CPC just after the execution of the first hop CPC.

New and/or Modified Messages:
SN Change Required (T-SN 1)* (c.f., FIGS. 11 (a) and (b)) is extended such that it contains the indication whether the configuration of the multiple CPC hops is allowed and if yes, what is the maximum number of allowed hops.
SN Addition Request Acknowledge* (c.f., FIGS. 11 (a) and (b)) is extended such that it contains the information for both an inter “first hop” CPC initiated by the S-SN and the subsequent “second hop” intra CPC initiated by the T-SN 1.
Subsequent CPC Confirm* (c.f., FIGS. 11 (a) and (b)) is an answer to the T-SN 1 concerning the “second hop” subsequent CPC initiated in the SN Addition Request Acknowledge*.
RRC Reconfiguration* and RRC Reconfiguration Complete* in FIG. 11 (a) are extended such that they contain the information about multiple CPC configuration hops (i.e., the information about CPC within CPC).

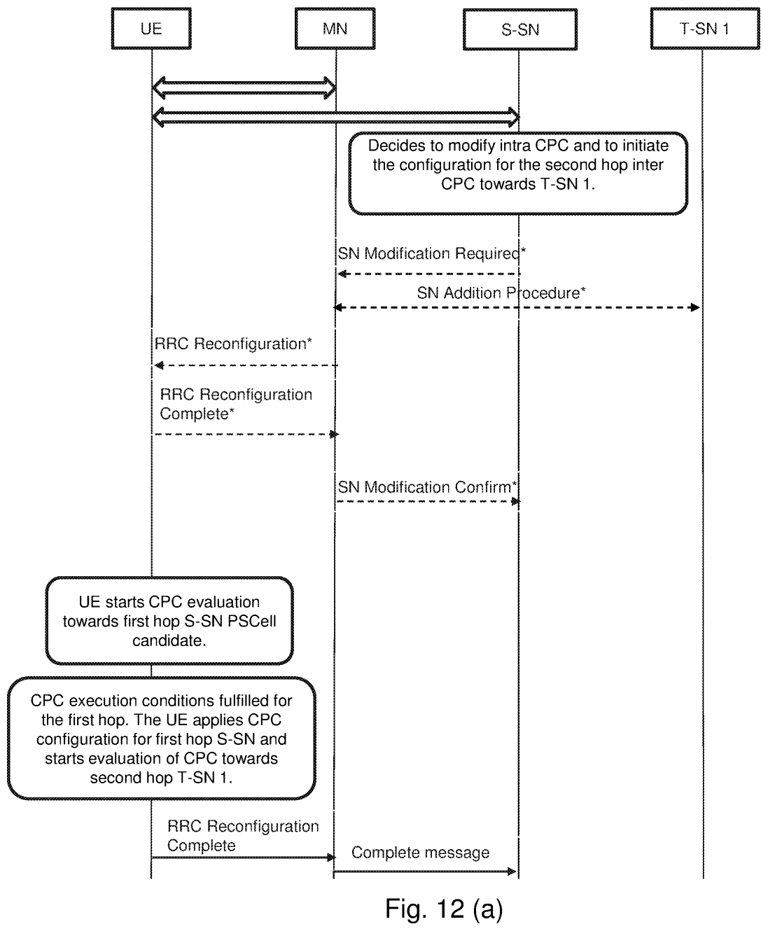

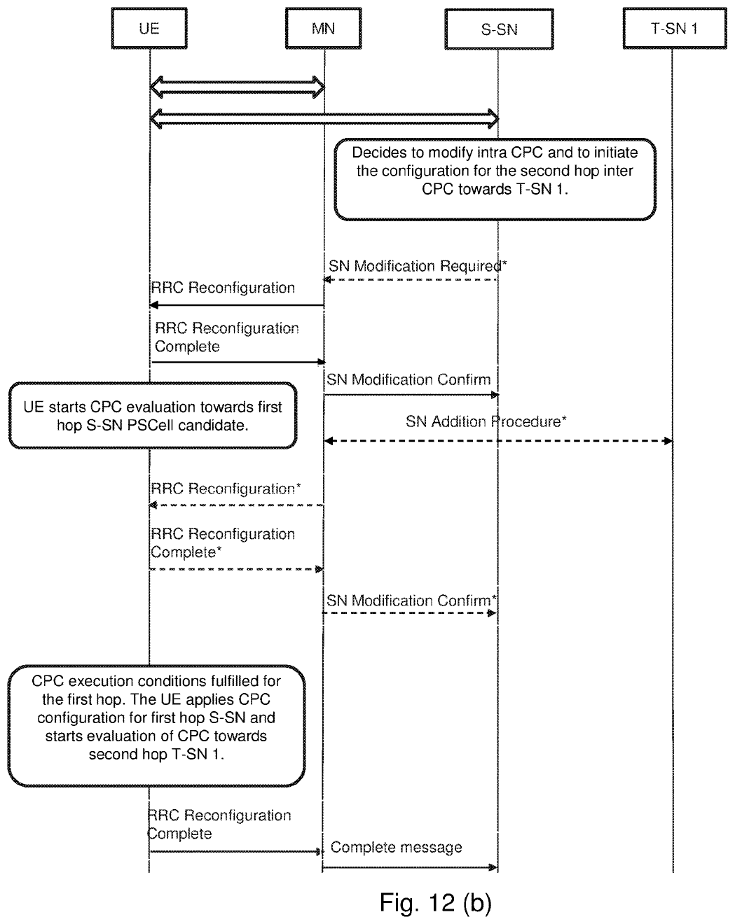

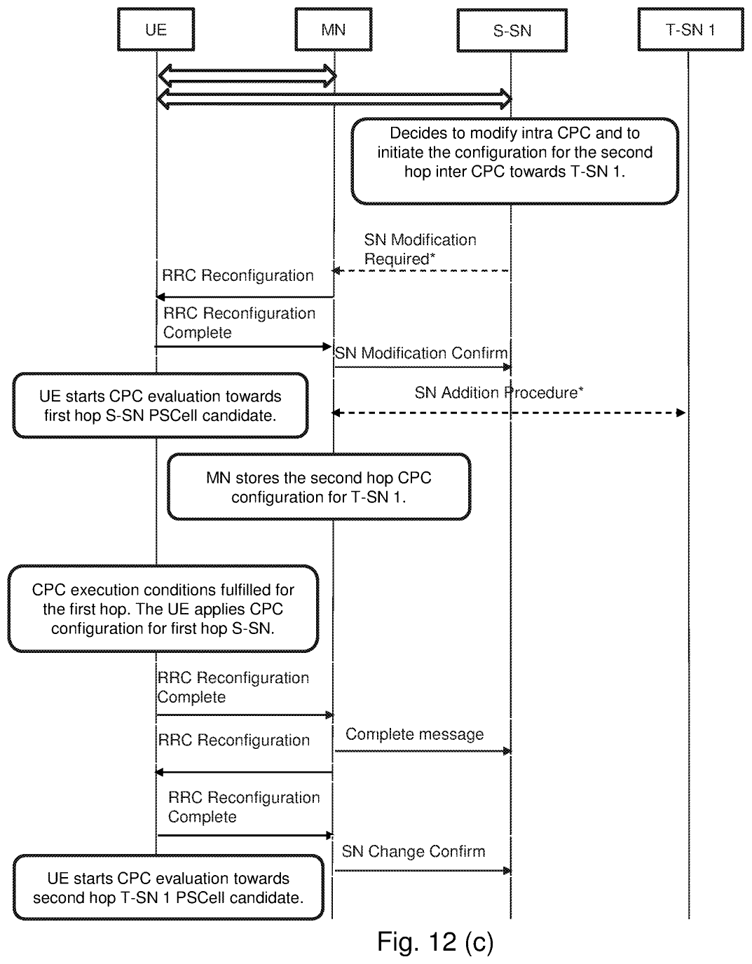

FIGS. 12 (a), (b), (c) show examples of the signalling for SN initiated multi-hop CPC configuration, intra-inter SN case, where (a) is CPC within CPC, (b) is second hop CPC before the execution of the first hop CPC and (c) is second hop CPC just after the execution of the first hop CPC.

New and/or Modified Messages:
SN Modification Required* (c.f., FIGS. 12 (a), (b), and (c)) is modified such that it contains the “first hop” intra CPC initiation indication and also the subsequent “second hop” inter CPC initiation indication.
SN Addition Procedure* (c.f., FIGS. 12 (a), (b), and (c)) is modified such that it is clear that T-SN 1 is the second hop CPC candidate.
SN Modification Confirm* (c.f., FIGS. 12 (a) and (b)) is extended such that it confirms both the “first hop” intra CPC and the “second hop” inter CPC.
RRC Reconfiguration* and RRC Reconfiguration Complete* in FIG. 12 (a) are extended such that they contain the information about multiple CPC configuration hops (i.e., the information about CPC within CPC).
RRC Reconfiguration* and RRC Reconfiguration Complete* in FIG. 12 (b) can be modified in two different ways:
Option 1: such that they contain the information about the encapsulated first and second hop CPCs (i.e., the information about CPC within CPC),
Option 2: such that they contain the information about the second hop CPC in a way that it is clear that the information concerns the future CPC that should be applied in the second hop and not in the first hop.

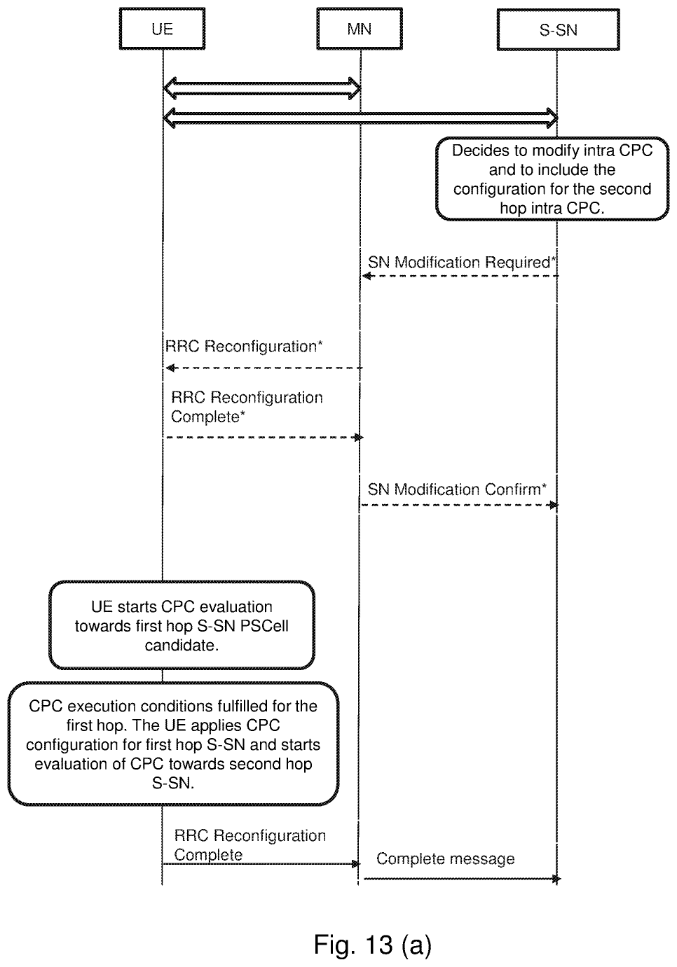

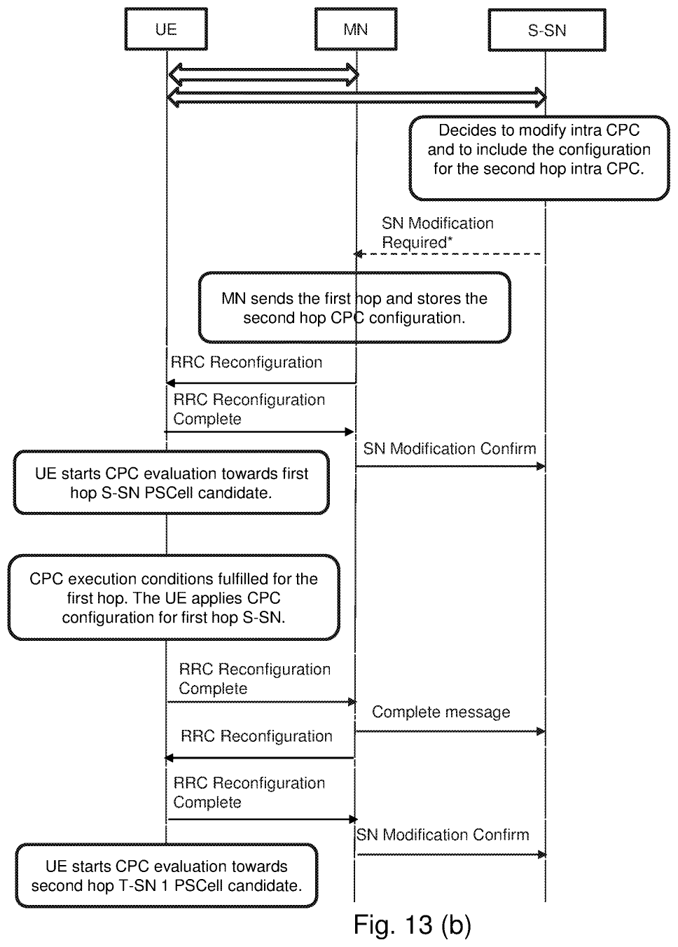

FIG. 13 (a), (b) show examples of the signalling for SN initiated multi-hop CPC configuration, intra-intra SN case, where (a) is CPC within CPC, (b) is second hop CPC just after the execution of the first hop CPC.

New and/or Modified Messages:
SN Modification Required* (c.f., FIGS. 13 (a) and (b)) is modified such that it contains the “first hop” intra CPC initiation indication and also the “second hop” intra CPC initiation indication.
SN Modification Confirm* in FIG. 13 (a) is extended such that it confirms both the “first hop” intra CPC and the “second hop” intra CPC.
RRC Reconfiguration* and RRC Reconfiguration Complete* in FIG. 13 (a) are extended such that they contain the information about multiple CPC configuration hops (i.e., the information about CPC within CPC).

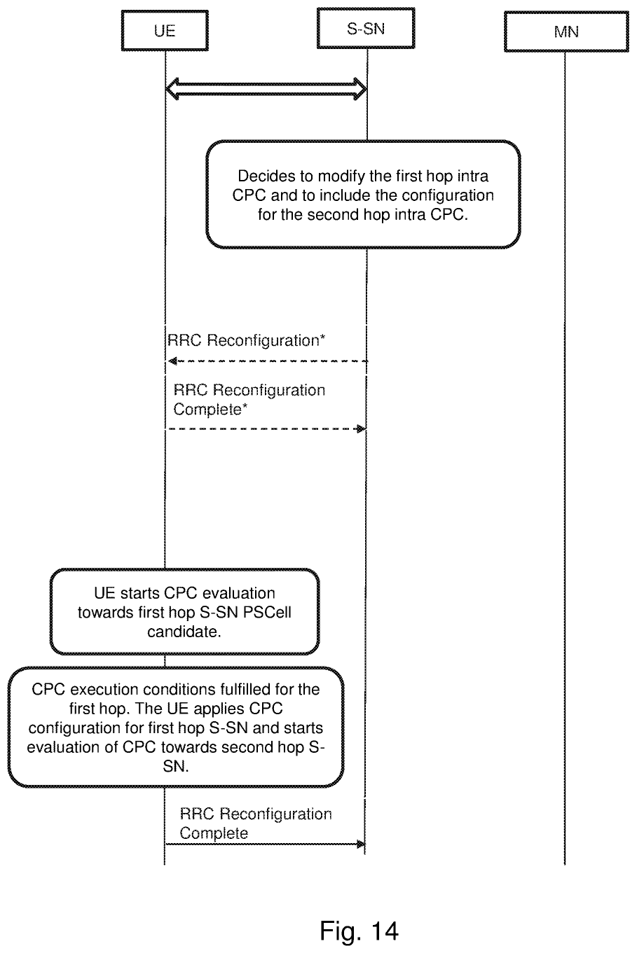

FIG. 14 shows an example of the signalling for SN initiated multi-hop CPC configuration, intra-intra SN case without MN involvement.

New and/or Modified Messages:
RRC Reconfiguration* and RRC Reconfiguration Complete* in FIG. 14 are extended such that they contain the information about multiple CPC configuration hops (i.e., the information about CPC within CPC).

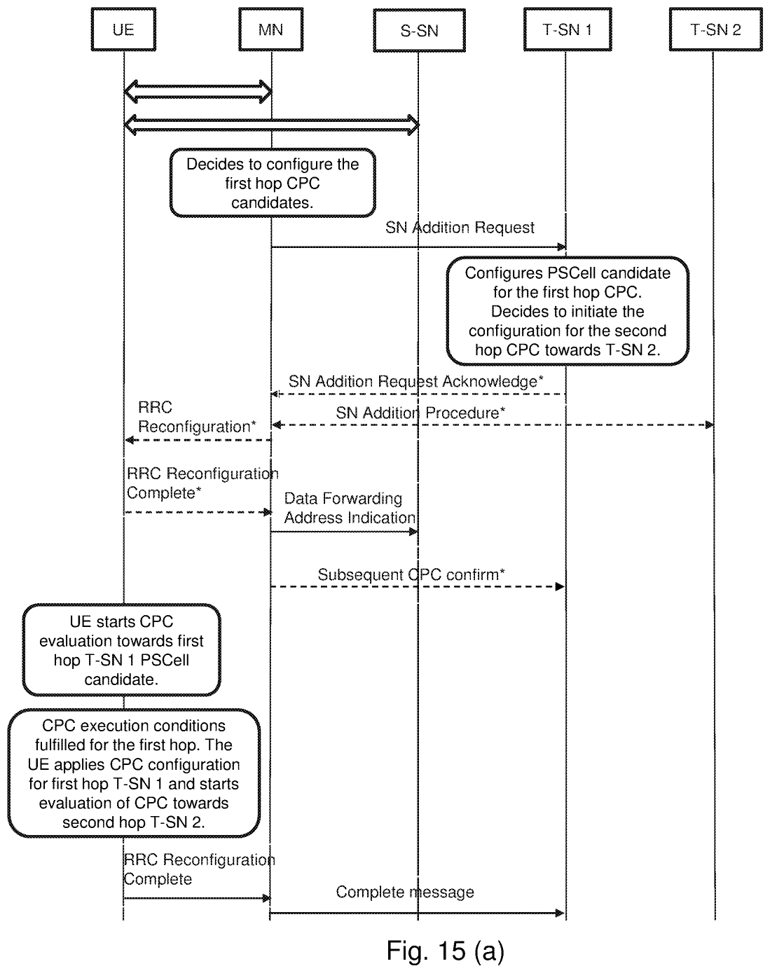

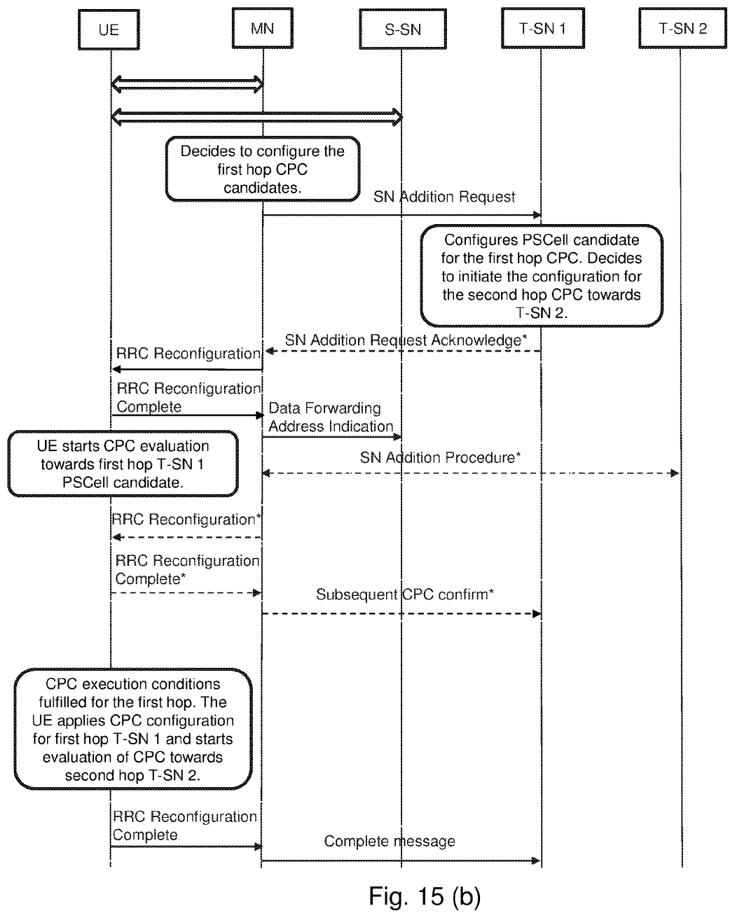

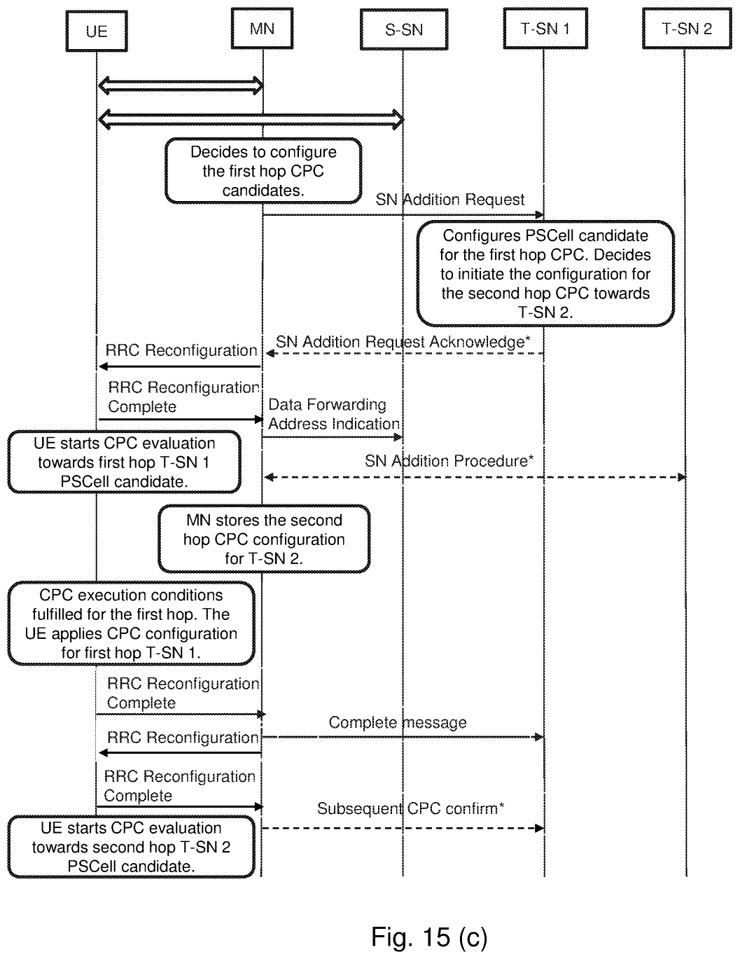

FIGS. 15 (a), (b), (c) show examples of the signalling for MN-SN initiated multi-hop CPC configuration, inter-inter SN case, where (a) is CPC within CPC, (b) is second hop CPC before the execution of the first hop CPC and (c) is second hop CPC just after the execution of the first hop CPC.

New and/or Modified Messages:
SN Addition Request Acknowledge* (c.f., FIGS. 15 (a), (b), and (c)) is extended such that it also contains an inter subsequent CPC initiation indication for T-SN 2 (i.e., it contains the information similar to the SN Change request).
SN Addition procedure* (c.f., FIGS. 15 (a), (b), and (c)) is modified such that it is clear that T-SN 2 is the “second hop” CPC candidate.
Subsequent CPC Confirm* (c.f., FIGS. 15 (a), (b), and (c)) is an answer to the SN Change request sent by the T-SN 1 in SN Addition Request Acknowledge* message (e.g., similar to the SN Change Confirm).
RRC Reconfiguration* and RRC Reconfiguration Complete* in FIG. 15 (a) are extended such that they contain the information about multiple CPC configuration hops (i.e., the information about CPC within CPC).
RRC Reconfiguration* and RRC Reconfiguration Complete* in FIG. 15 (b) can be modified in two different ways:
Option 1: such that they contain the information about the encapsulated first and second hop CPCs (i.e., the information about CPC within CPC),
Option 2: such that they contain the information about the second hop CPC in a way that it is clear that the information concerns the future CPC that should be applied in the second hop and not in the first hop.

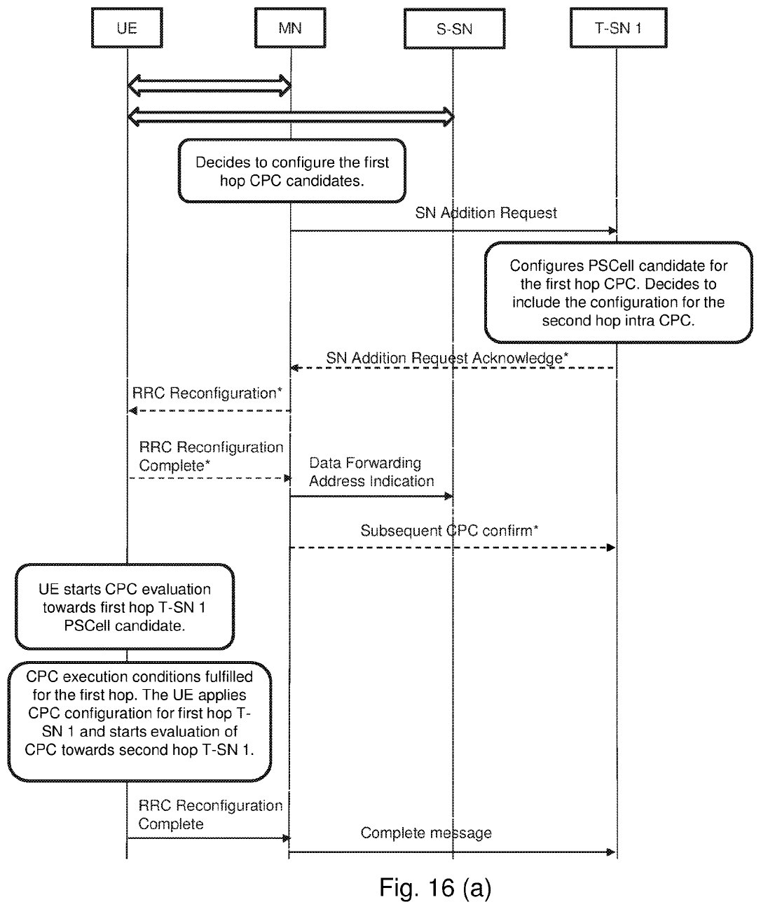

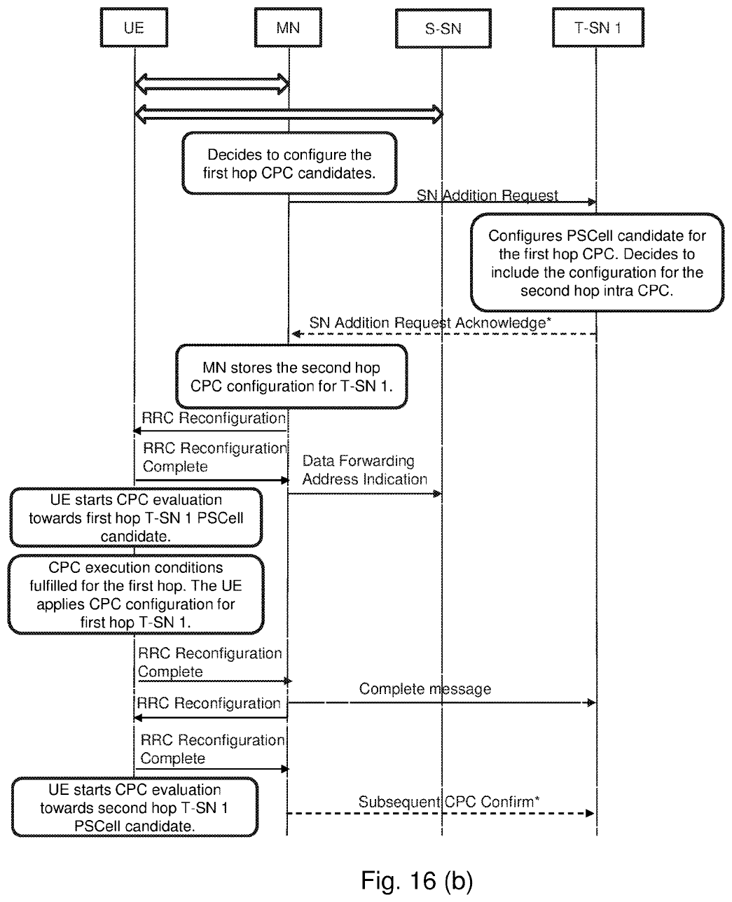

FIGS. 16 (a), (b) show examples of the signalling for MN-SN initiated multi-hop CPC configuration, inter-intra SN case, where (a) is CPC within CPC, (b) is second hop CPC just after the execution of the first hop CPC.

New and/or Modified Messages:
SN Addition Request Acknowledge* (c.f. FIGS. 16 (a) and (b)) is extended such that it contains the information about both an inter “first hop” CPC initiated by the MN and the subsequent intra “second hop” CPC initiated by the T-SN 1.
Subsequent CPC Confirm* (c.f. FIGS. 16 (a) and (b)) is an answer to the SN Change request sent by the T-SN 1 in SN Addition Request Acknowledge* message (e.g., similar to the SN Change Confirm).
RRC Reconfiguration* and RRC Reconfiguration Complete* in FIG. 16 (a) are extended such that they contain the information about multiple CPC configuration hops (i.e., the information about CPC within CPC).

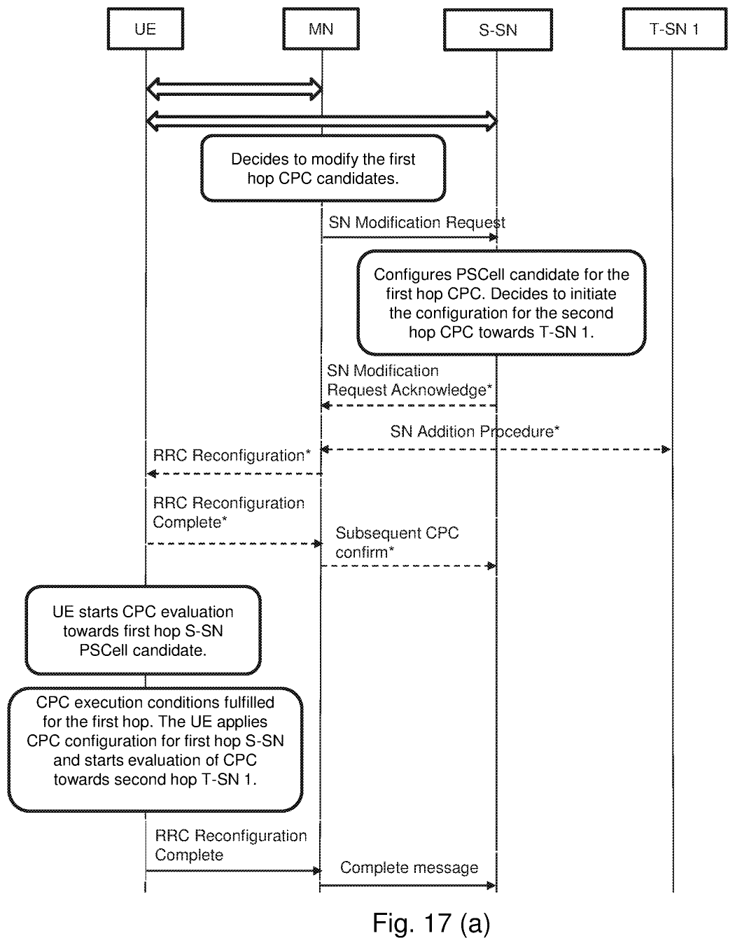

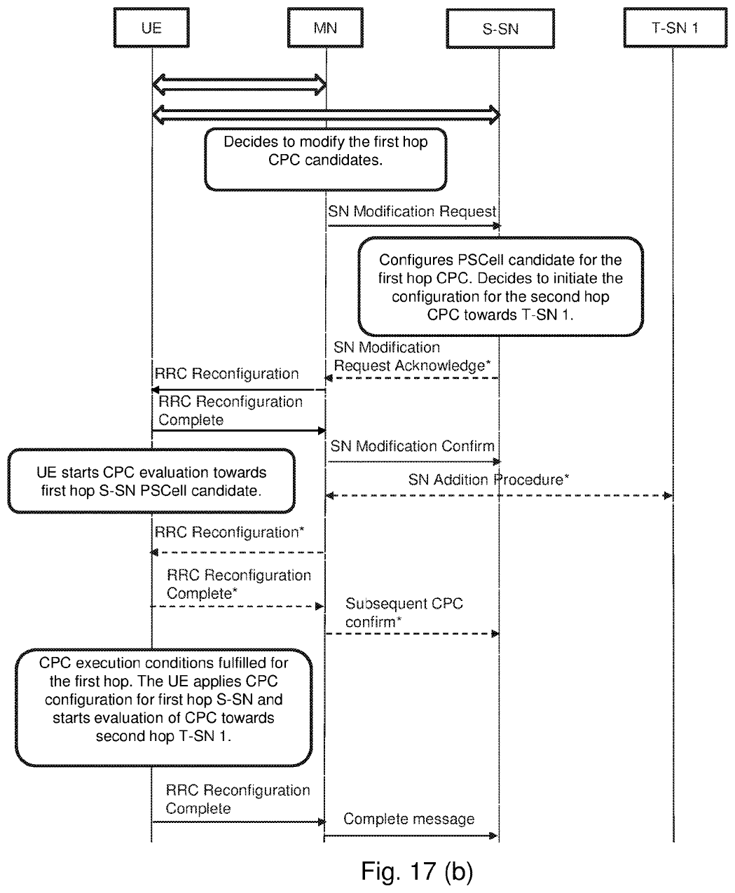

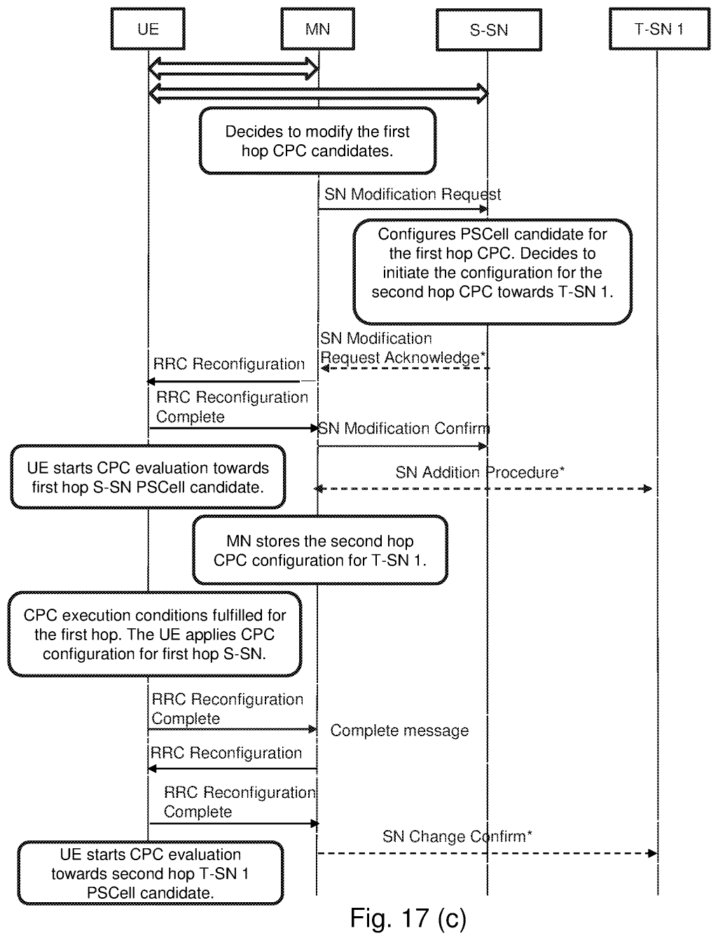

FIGS. 17 (a), (b), (c) show examples of the signalling for MN-SN initiated multi-hop CPC configuration, intra-inter SN case, where (a) is CPC within CPC, (b) is second hop CPC before the execution of the first hop CPC and (c) is second hop CPC just after the execution of the first hop CPC.

New and/or Modified Messages:
SN Modification Request Acknowledge* (c.f., FIGS. 17 (a), (b), and (c)) is extended such that it contains the information for both an intra “first hop” CPC initiated by the MN and the subsequent inter “second hop” CPC initiated by the S-SN.
SN Addition procedure* (c.f., FIGS. 17 (a), (b), and (c)) is modified such that it is clear that T-SN 1 is the second hop CPC candidate.
Subsequent CPC Confirm* (c.f., FIGS. 17 (a), (b), and (c)) is an answer to the SN Change request sent by the S-SN in SN Modification Request Acknowledge* message (e.g., similar to the SN Change Confirm).
RRC Reconfiguration* and RRC Reconfiguration Complete* in FIG. 17 (a) are extended such that they contain the information about multiple CPC configuration hops i.e., the information about CPC within CPC.
RRC Reconfiguration* and RRC Reconfiguration Complete* in FIG. 17 (b) can be modified in two different ways:
Option 1: such that they contain the information about the encapsulated first and second hop CPCs (i.e., the information about CPC within CPC),
Option 2: such that they contain the information about the second hop CPC in a way that it is clear that the information concerns the future CPC that should be applied in the second hop and not in the first hop.

### Examples Concerning ASN and Procedure Updates in the Case of the CPC within CPC Solution

The following examples illustrate some of the changes to the implementation in TS 38.331 that are needed for configuring the multi-hop CPC.

### CondReconfigToAddModList

The IE CondReconfigToAddModList concerns a list of conditional reconfigurations to add or modify, with for each entry the condReconfigId and the associated condExecutionCond/condExecutionCondSCG and condRRCReconfig.

-- ASNISTART
-- TAG-CONDRECONFIGTOADDMODLIST-START
CondReconfigToAddModList-r16 ::= SEQUENCE (SIZE (1.. maxNrofCondCells-r16)) OF
CondReconfigToAddMod-r16
CondReconfigToAddMod-r16 ::= SEQUENCE {

| | |
|---|---|
| condReconfigId-r16 | CondReconfigId-r16, |
| condExecutionCond-r16 | SEQUENCE (SIZE (1..2)) OF MeasId OPTIONAL, -- Need M |
| condRRCReconfig-r16 | OCTET STRING (CONTAINING RRCReconfiguration) OPTIONAL, - - |

```
Cond condReconfigAdd
    ...,
    [[
    condExecutionCondSCG-r17 OCTET STRING (CONTAINING CondReconfigExecCondSCG-r-17)
OPTIONAL -- Need M
    ]]
}
CondReconfigExecCondSCG-r17 ::= SEQUENCE (SIZE (1..2)) OF MeasId
-- TAG-CONDRECONFIGTOADDMODLIST-STOP
-- ASN1STOP
```

CondReconfigToAddMod field descriptions

condExecutionCond
The execution condition that needs to be fulfilled in order to trigger the execution of a conditional reconfiguration for CHO,
CPA, intra-SN CPC without MN involvement or MN initiated inter-SN CPC. When configuring 2 triggering events (Meas Ids)
for a candidate cell, network ensures that both refer to the same measObject. If network configures condEventD1 or
condEventT1 for a candidate cell network configures a second triggering event condEventA3, condEventA4 or
condEventA5. Network does not configure both condEventD1 or condEventT1 for the same candidate cell. For CPAC, the
RRCReconfiguration message contained in condRRCReconfig cannot contain the field scg-State.
condExecutionCondSCG
Contains execution condition that needs to be fulfilled in order to trigger the execution of a conditional reconfiguration for
SN initiated inter-SN CPC. The Meas Ids refer to the measConfig associated with the SCG. When configuring 2 triggering
events (Meas Ids) for a candidate cell, network ensures that both refer to the same measObject. For each
condReconfigurationId, the network always configures either triggerCondition or triggerConditionSCG (not both).
condRRCReconfig
The RRCReconfiguration message to be applied when the condition(s) are fulfilled. The RRCReconfiguration message
contained in condRRCReconfig can [symbol] contain the field conditionalReconfiguration (up to X encaptulations), the field
daps-Config or the configuration for target SCG for CHO.

| Conditional Presence | Explanation |
|---|---|
| condReconfigAdd | The field is mandatory present |
| | when a condReconfigId is being added. |
| | Otherwise the field is optional, need M. |

### Reception of an RRCReconfiguration by the UE

The UE shall perform the following actions upon reception of the RRCReconfiguration, or upon execution of the conditional reconfiguration (CHO, CPA or CPC):

| 1> | if the RRCReconfiguration was received neither within mrdc-SecondaryCellGroup nor within E- | |
|---|---|---|
| | UTRA RRCConnectionReconfiguration nor within E-UTRA RRCConnectionResume: | |
| | 2> | if the RRCReconfiguration includes the scg-State: |

| | |
|---|---|
| 3> | perform SCG deactivation as specified in 5.3.5.13b; |

| | |
|---|---|
| 2> | else: |

| | |
|---|---|
| 3> | perform SCG activation as specified in 5.3.5.13a; |

Editor's note: FFS how to ensure that the notification to MAC is only processed at the time the SCG

configuration is processed, if included.

| 1> | if the RRCReconfiguration is applied due to a conditional reconfiguration execution upon cell | |
|---|---|---|
| | selection performed while timer T311 was running, as defined in 5.3.7.3: | |
| | 2> | if the RRCReconfiguration includes keepConditional: |
| | 3> keep all the entries within VarConditionalReconfig, if any, except the one that triggered this | |
| | | conditional reconfiguration; |
| | 2> | else: |

```
  3> remove all the entries within VarConditionalReconfig, if any;
  ...
```

### Examples Concerning the Structure of the RRC Reconfiguration Message

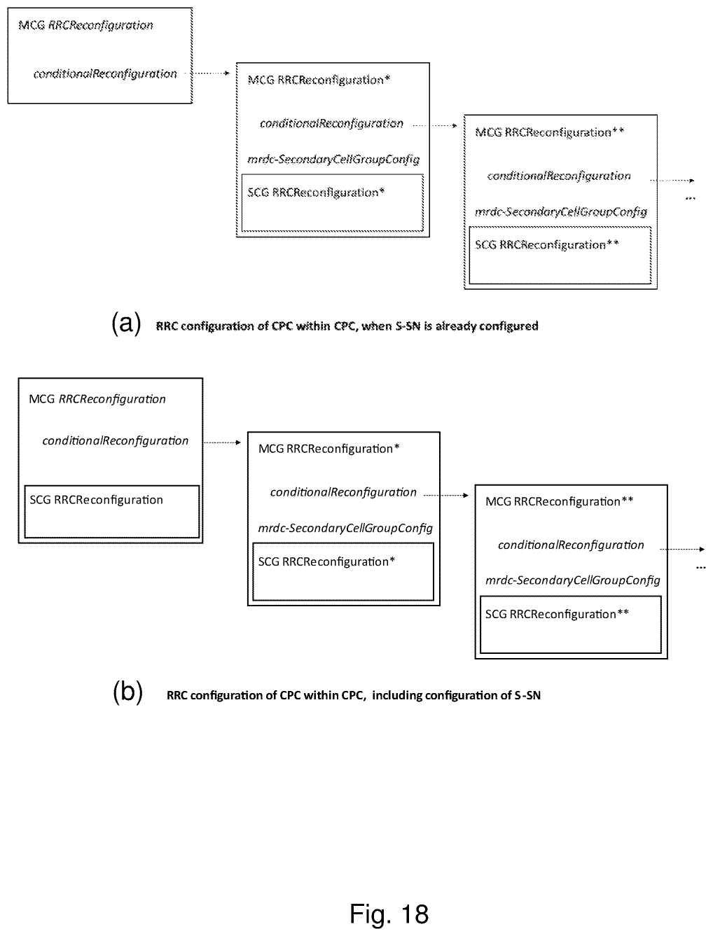

FIGS. 18 (a) and (b) show examples that illustrate the structure of the RRC Reconfiguration message in the case of the CPC within CPC solution for the multi-hop CPC configuration. In particular, the examples illustrate the CPC within CPC encapsulation inside of the RRC Reconfiguration message that is sent to the UE.

### Example Implementation in XnAP TS 38.423

### 9.1.2.1 S-Node Addition Request

This message is sent by the M-NG-RAN node to the S-NG-RAN node to request the preparation of resources for dual connectivity operation for a specific UE.
Direction: M-NG-RAN node→S-NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN node UE | M | | NG-RAN node | Allocated at the M- | YES | reject |
| XnAP ID | | | UE XnAP ID | NG-RAN node | | |
| | | | 9.2.3.16 | | | |
| UE Security | M | | 9.2.3.49 | | YES | reject |
| Capabilities | | | | | | |
| S-NG-RAN node | M | | 9.2.3.51 | | YES | reject |
| Security Key | | | | | | |
| S-NG-RAN node UE | M | | UE Aggregate | The UE Aggregate | YES | reject |
| Aggregate Maximum | | | Maximum Bit | Maximum Bit Rate is | | |
| Bit Rate | | | Rate | split into M-NG-RAN | | |
| | | | 9.2.3.17 | node UE Aggregate | | |
| | | | | Maximum Bit Rate | | |
| | | | | and S-NG-RAN | | |
| | | | | node UE Aggregate | | |
| | | | | Maximum Bit Rate | | |
| | | | | which are enforced | | |
| | | | | by M-NG-RAN node | | |
| | | | | and S-NG-RAN | | |
| | | | | node respectively. | | |
| Selected PLMN | O | | PLMN Identity | The selected PLMN | YES | ignore |
| | | | 9.2.2.4 | of the SCG in the S- | | |
| | | | | NG-RAN node. | | |
| Mobility Restriction | O | | 9.2.3.53 | | YES | ignore |
| List | | | | | | |
| Index to | O | | 9.2.3.23 | | YES | reject |
| RAT/Frequency | | | | | | |
| Selection Priority | | | | | | |
| PDU Session | | 1 | | | YES | reject |
| Resources To Be | | | | | | |
| Added List | | | | | | |
| >PDU Session | | 1 . . . <maxnoofPDUSessions> | | NOTE: If neither the | — | |
| Resources To Be | | | | PDU Session | | |
| Added Item | | | | Resource Setup Info - | | |
| | | | | SN terminated IE | | |
| | | | | nor the | | |
| | | | | PDU Session | | |
| | | | | Resource Setup Info - | | |
| | | | | MN terminated IE | | |
| | | | | is present in a PDU | | |
| | | | | Session Resources | | |
| | | | | To Be Added Item | | |
| | | | | IE, abnormal | | |
| | | | | conditions as | | |
| | | | | specified in clause | | |
| | | | | 8.3.1.4 apply. | | |
| >>PDU Session ID | M | | 9.2.3.18 | | — | |
| >>S-NSSAI | M | | 9.2.3.21 | | — | |
| >>S-NG-RAN | O | | PDU Session | | — | |
| node PDU Session | | | Aggregate | | | |
| Aggregate | | | Maximum Bit | | | |
| Maximum Bit Rate | | | Rate | | | |
| | | | 9.2.3.69 | | | |
| >>PDU Session | O | | 9.2.1.5 | | — | |
| Resource Setup | | | | | | |
| Info - SN | | | | | | |
| terminated | | | | | | |
| >>PDU Session | O | | 9.2.1.7 | | — | |
| Resource Setup | | | | | | |
| Info - MN | | | | | | |
| terminated | | | | | | |
| M-NG-RAN node to | M | | OCTET STRING | Includes the CG- | YES | reject |
| S-NG-RAN node | | | | ConfigInfo message | | |
| Container | | | | as defined in | | |
| | | | | subclause 11.2.2 of | | |
| | | | | TS 38.331 [10] | | |
| S-NG-RAN node UE | O | | NG-RAN node | Allocated at the S- | YES | reject |
| XnAP ID | | | UE XnAP ID | NG-RAN node | | |
| | | | 9.2.3.16 | | | |
| Expected UE | O | | 9.2.3.81 | | YES | ignore |
| Behaviour | | | | | | |
| Requested Split | O | | ENUMERATED | Indicates that | YES | reject |
| SRBs | | | (srb1, srb2, | resources for Split | | |
| | | | srb1&2, . . . ) | SRBs are requested. | | |
| PCell ID | O | | Global NG-RAN | | YES | reject |
| | | | Cell Identity | | | |
| | | | 9.2.2.27 | | | |
| Desired Activity | O | | 9.2.3.77 | | YES | ignore |
| Notification Level | | | | | | |
| Available DRB IDs | C- | | DRB List | Indicates the list of | YES | reject |
| | ifSNterminated | | 9.2.1.29 | DRB IDs that the S- | | |
| | | | | NG-RAN node may | | |
| | | | | use for SN- | | |
| | | | | terminated bearers. | | |
| S-NG-RAN node | O | | Bit Rate | The S-NG-RAN | YES | reject |
| Maximum Integrity | | | 9.2.3.4 | node Maximum | | |
| Protected Data Rate | | | | Integrity Protected | | |
| Uplink | | | | Data Rate Uplink is | | |
| | | | | a portion of the UE's | | |
| | | | | Maximum Integrity | | |
| | | | | Protected Data Rate | | |
| | | | | in the Uplink, which | | |
| | | | | is enforced by the S- | | |
| | | | | NG-RAN node for | | |
| | | | | the UE's SN | | |
| | | | | terminated PDU | | |
| | | | | sessions. If the S- | | |
| | | | | NG-RAN node | | |
| | | | | Maximum Integrity | | |
| | | | | Protected Data Rate | | |
| | | | | Downlink IE is not | | |
| | | | | present, this IE | | |
| | | | | applies to both UL | | |
| | | | | and DL. | | |
| S-NG-RAN node | O | | Bit Rate | The S-NG-RAN | YES | reject |
| Maximum Integrity | | | 9.2.3.4 | node Maximum | | |
| Protected Data Rate | | | | Integrity Protected | | |
| Downlink | | | | Data Rate Downlink | | |
| | | | | is a portion of the | | |
| | | | | UE's Maximum | | |
| | | | | Integrity Protected | | |
| | | | | Data Rate in the | | |
| | | | | Downlink, which is | | |
| | | | | enforced by the S- | | |
| | | | | NG-RAN node for | | |
| | | | | the UE's SN | | |
| | | | | terminated PDU | | |
| | | | | sessions. | | |
| Location Information | O | | ENUMERATED | Indicates that the | YES | ignore |
| at S-NODE reporting | | | (pscell, . . . ) | user's Location | | |
| | | | | Information at S- | | |
| | | | | NODE is to be | | |
| | | | | provided. | | |
| MR-DC Resource | O | | 9.2.2.33 | Information used to | YES | ignore |
| Coordination | | | | coordinate resource | | |
| Information | | | | utilisation between | | |
| | | | | M-NG-RAN node | | |
| | | | | and S-NG-RAN | | |
| | | | | node. | | |
| Masked IMEISV | O | | 9.2.3.32 | | YES | ignore |
| NE-DC TDM Pattern | O | | 9.2.2.38 | | YES | ignore |
| SN Addition Trigger | O | | ENUMERATED | This IE indicates the | YES | reject |
| Indication | | | (SN change, | trigger for S-NG- | | |
| | | | inter-MN HO, | RAN node Addition | | |
| | | | intra-MN HO, . . . ) | Preparation | | |
| | | | | procedure | | |
| Trace Activation | O | | 9.2.3.55 | | YES | ignore |
| Requested Fast MCG | O | | ENUMERATED | Indicates that the | YES | ignore |
| recovery via SRB3 | | | (true, . . . ) | resources for fast | | |
| | | | | MCG recovery via | | |
| | | | | SRB3 are | | |
| | | | | requested. | | |
| UE Radio Capability | O | | 9.2.3.138 | | YES | reject |
| ID | | | | | | |
| Source NG-RAN | O | | Global NG-RAN | The NG-RAN Node | YES | ignore |
| Node ID | | | Node ID | ID of the source NG- | | |
| | | | 9.2.2.3 | RAN node or the | | |
| | | | | source SN. | | |
| Management Based | O | | MDT PLMN List | | YES | ignore |
| MDT PLMN List | | | 9.2.3.133 | | | |
| UE History | O | | 9.2.3.64 | | YES | ignore |
| Information | | | | | | |
| UE History | O | | 9.2.3.110 | | YES | ignore |
| Information from the | | | | | | |
| UE | | | | | | |
| PSCell Change | O | | ENUMERATED | | YES | ignore |
| History | | | (reporting full | | | |
| | | | history, . . . ) | | | |
| IAB Node Indication | O | | ENUMERATED | | YES | ignore |
| | | | (true, . . . ) | | | |
| No PDU Session | O | | ENUMERATED | Applicable to IAB- | YES | ignore |
| Indication | | | (true, . . . ) | MT only. | | |
| CHO Information SN | O | | | | YES | reject |
| Addition | | | | | | |
| >Source M-NG-RAN | M | | Global NG-RAN | | — | |
| node ID | | | Node ID | | | |
| | | | 9.2.2.3 | | | |
| >Source M-NG-RAN | M | | NG-RAN node | Allocated at the | — | |
| node UE XnAP ID | | | UE XnAP ID | source M-NG-RAN | | |
| | | | 9.2.3.16 | node | | |
| >Estimated Arrival | O | | INTEGER | | — | |
| Probability | | | (1 . . . 100) | | | |
| SCG Activation | O | | 9.2.3.154 | | YES | ignore |
| Request | | | | | | |
| Conditional PSCell | O | | | | YES | reject |
| Addition | | | | | | |
| Information Request | | | | | | |
| >Maximum Number | M | | INTEGER | Indicates the | — | |
| of PSCells To | | | (1 . . . 8, . . . ) | maximum number of | | |
| Prepare | | | | PSCells that the | | |
| | | | | target SN may | | |
| | | | | prepare. | | |
| >Estimated Arrival | O | | INTEGER | Indicates the arrival | — | |
| Probability | | | (1 . . . 100) | probability for the | | |
| | | | | UE towards the | | |
| | | | | candidate target SN. | | |
| >S-NG-RAN node | M | | OCTET STRING | Includes the CG- | — | |
| to M-NG-RAN node | | | | Config message or | | |
| Container for | | | | the CG- | | |
| subsequent CPC | | | | CandidateList | | |
| configurations | | | | message as | | |
| | | | | defined in | | |
| | | | | subclause 11.2.2 of | | |
| | | | | TS 38.331 [10]. | | |
| S-NG-RAN node UE | O | | UE Slice | This IE indicates the | YES | reject |
| Slice Maximum Bit | | | Maximum Bit | S-NG-RAN node | | |
| Rate | | | Rate List | portion of the UE | | |
| | | | 9.2.3.167 | Slice Aggregate | | |
| | | | | Maximum Bit Rate | | |
| | | | | as specified in TS | | |
| | | | | 23.501 [7] | | |

| Range bound | Explanation |
|---|---|
| maxnoofPDUSessions | Maximum no. of PDU sessions. Value is 256 |

| Condition | Explanation |
|---|---|
| ifSNterminated | This IE shall be present if there |
| | is at least one PDU Session |
| | Resource Setup Info - SN terminated |
| | in the PDU Session |
| | Resources To Be Added List IE. |

### 9.1.2.2 S-Node Addition Request Acknowledge

This message is sent by the S-NG-RAN node to confirm the M-NG-RAN node about the S-NG-RAN node addition preparation.
Direction: S-NG-RAN node→M-NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN node UE | M | | NG-RAN node UE | Allocated at the M- | YES | reject |
| XnAP ID | | | XnAP ID | NG-RAN node | | |
| | | | 9.2.3.16 | | | |
| S-NG-RAN node UE | M | | NG-RAN node UE | Allocated at the S- | YES | reject |
| XnAP ID | | | XnAP ID | NG-RAN node | | |
| | | | 9.2.3.16 | | | |
| PDU Session | | 1 | | | YES | ignore |
| Resources Admitted | | | | | | |
| To Be Added List | | | | | | |
| >PDU Session | | 1 . . . <maxnoofPDUSessions> | | NOTE: If neither the | — | |
| Resources | | | | PDU Session | | |
| Admitted To Be | | | | Resource Setup | | |
| Added Item | | | | Response Info - SN | | |
| | | | | terminated IE | | |
| | | | | nor the | | |
| | | | | PDU Session | | |
| | | | | Resource Setup | | |
| | | | | Response Info - MN | | |
| | | | | terminated IE | | |
| | | | | is present in a PDU | | |
| | | | | Session Resources | | |
| | | | | Admitted to be Added | | |
| | | | | Item IE, abnormal | | |
| | | | | conditions as | | |
| | | | | specified in clause | | |
| | | | | 8.3.1.4 apply. | | |
| >>PDU Session ID | M | | 9.2.3.18 | | — | |
| >>PDU Session | O | | 9.2.1.6 | | — | |
| Resource Setup | | | | | | |
| Response Info - | | | | | | |
| SN terminated | | | | | | |
| >>PDU Session | O | | 9.2.1.8 | | — | |
| Resource Setup | | | | | | |
| Response Info | | | | | | |
| MN terminated | | | | | | |
| PDU Session | O | | | | YES | ignore |
| Resources Not | | | | | | |
| Admitted List | | | | | | |
| >PDU Session | O | | PDU Session | | — | |
| Resources Not | | | Resources Not | | | |
| Admitted List - SN | | | Admitted List | | | |
| terminated | | | 9.2.1.3 | | | |
| >PDU Session | O | | PDU Session | | — | |
| Resources Not | | | Resources Not | | | |
| Admitted List - MN | | | Admitted List | | | |
| terminated | | | 9.2.1.3 | | | |
| S-NG-RAN node to | M | | OCTET STRING | Includes the CG- | YES | reject |
| M-NG-RAN node | | | | Config message or | | |
| Container | | | | the CG-CandidateList | | |
| | | | | message as defined | | |
| | | | | in subclause 11.2.2 of | | |
| | | | | TS 38.331 [10]. | | |
| Admitted Split SRBs | O | | ENUMERATED | Indicates admitted | YES | reject |
| | | | (srb1, srb2, | SRBs | | |
| | | | srb1&2, . . . ) | | | |
| RRC Config | O | | 9.2.3.72 | | YES | reject |
| Indication | | | | | | |
| Criticality Diagnostics | O | | 9.2.3.3 | | YES | ignore |
| Location Information | O | | Target Cell Global | Contains information | YES | ignore |
| at S-NODE | | | ID | to support localisation | | |
| | | | 9.2.3.25 | of the UE | | |
| MR-DC Resource | O | | 9.2.2.33 | Information used to | YES | ignore |
| Coordination | | | | coordinate resource | | |
| Information | | | | utilisation between M- | | |
| | | | | NG-RAN node and S- | | |
| | | | | NG-RAN node. | | |
| Available fast MCG | O | | ENUMERATED | Indicates the fast | YES | ignore |
| recovery via SRB3 | | | (true, . . . ) | MCG recovery via | | |
| | | | | SRB3 is enabled. | | |
| Direct Forwarding | O | | ENUMERATED | Indicates direct | YES | ignore |
| Path Availability | | | (direct path | forwarding path is | | |
| | | | available, . . . ) | available between the | | |
| | | | | target S-NG-RAN | | |
| | | | | node and source NG- | | |
| | | | | RAN node for intra- | | |
| | | | | system handover or | | |
| | | | | between the target S- | | |
| | | | | NG-RAN node and | | |
| | | | | the source SN. | | |
| SCG Activation | O | | 9.2.3.155 | | YES | ignore |
| Status | | | | | | |
| Conditional PSCell | O | | | | YES | ignore |
| Addition | | | | | | |
| Information | | | | | | |
| Acknowledge | | | | | | |
| >Candidate PSCell | | 1 | | | — | |
| ID List | | | | | | |
| >>Candidate | | 1 . . . <maxnoofPSCellCandidate> | | | — | |
| PSCell ID Item | | | | | | |
| >>>PSCell ID | M | | NR CGI 9.2.2.7 | | — | |
| >S-NG-RAN node | M | | OCTET STRING | Includes the CG- | — | |
| to M-NG-RAN node | | | | Config message or | | |
| Container for | | | | the CG- | | |
| subsequent CPC | | | | CandidateList | | |
| configurations | | | | message as defined | | |
| | | | | in subclause 11.2.2 | | |
| | | | | of TS 38.331 [10]. | | |

| Range bound | Explanation |
|---|---|
| maxnoofPDUSessions | Maximum no. of PDU sessions. Value is 256 |
| maxnoofPSCellCandidate | Maximum no, of PSCell candidate. Value is 8 |

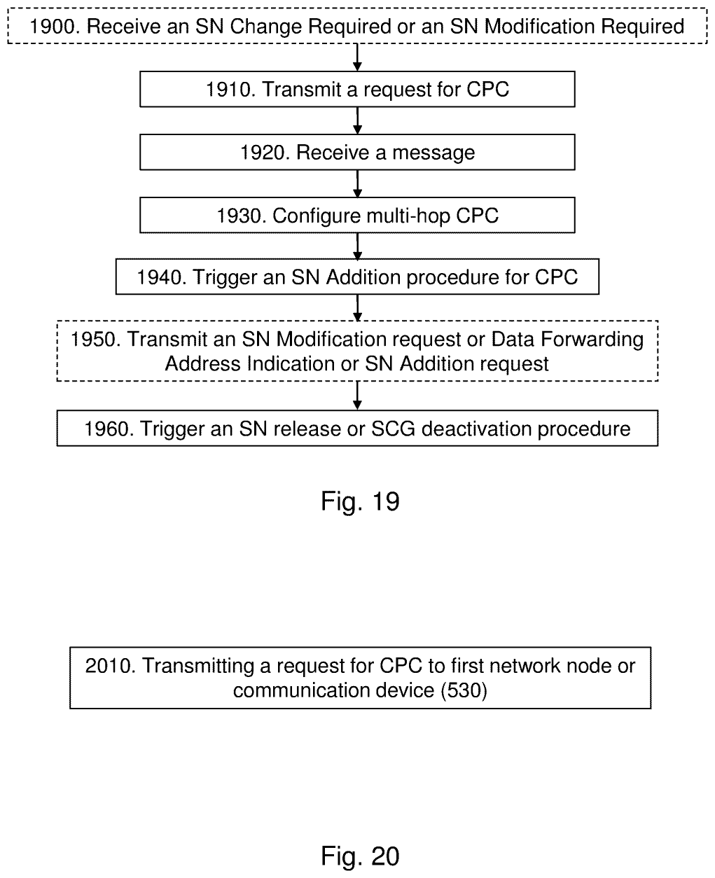

According to embodiments herein, a method performed in the first network node 511 for handling multi-hop configuration of conditional primary secondary cell change or primary secondary cell group cell change (CPC) for the communication device 530, 531 will be described with reference to FIG. 19. The communication device 530, 531 is configured with dual connectivity with a master cell group (MCG) managed by the first network node 511, and a secondary cell group (SCG) managed by a second network node 512, in a wireless communication network 500. The method comprises the following actions which may be performed in any suitable order.

### Action 1900

This action is optional. The first network node 511 may receive an SN Change Required from the second network node 512 in case an inter-SN-CPC first hop configuration is initiated by the second network node 512.

The first network node 511 may receive an SN Modification Required from the second network node 512 in case an intra-SN-CPC first hop configuration is initiated by the second network node 512.

### Action 1910

The first network node 511 transmits a request for CPC to the second network node 512 or a first target candidate Secondary Node T-SN1. The request for CPC may comprise one or more of the following:
a configuration for a first hop or a part of configuration to be applied at a first hop CPC;
an indication on which CPC hop that is requested;
an indication on the maximum number of CPC hops the communication device supports.

### Action 1920

The first network node 511 receives a message from the second network node 512 or the first target candidate SN (T-SN1) in response to the request for CPC. The message comprises one or more of the following information:
i. an indication indicating that the CPC configuration is a multi-hop CPC configuration,
ii. an indication about whether it is time critical to configure a first hop CPC;
ii. an indication about how many hops ahead to be configured;
iii. identifier(s) of one or more target candidate primary secondary cells (PSCells) for the second hop CPC configuration;
iv. identifier(s) of one or more target candidate secondary node(s), T-SN2 associated to the one or more target candidate PSCells.

### Action 1930

The first network node 511 configures multi-hop CPC for the communication device 530, 531 based on the received message. This may be performed by creating a Reconfiguration message that contains information about both a first hop CPC configuration and a next hop CPC configuration and sending this Reconfiguration message to the communication device 530, 531.

The first network node 511 may also configure multi-hop CPC for the communication device 530, 531 based on the received message by any one of the following:
Creating a first Reconfiguration message that contains information about a first hop CPC configuration and sending the first Reconfiguration message to the communication device, then creating a second Reconfiguration message that contains information about a next hop CPC configuration and send this second Reconfiguration message to the communication device;
Creating a first Reconfiguration message that contains information about a first hop CPC configuration and sending the first Reconfiguration message to the communication device, then storing information about a next hop CPC configuration and sending a second Reconfiguration message containing the information about the next hop CPC configuration after the execution of the first hop CPC to the communication device.

According to some embodiments herein, the method may further comprise the following actions.

### Action 1940

The first network node 511 triggers an SN Addition procedure for CPC to the one or more target candidate SN(s) indicated by the second network node 512 or the first target candidate SN T-SN1 for the one or more target candidate PSCells in the second hop CPC configuration.

The first network node 511 may trigger an SN Addition procedure for CPC by transmitting an SN Addition Request for CPC to a second target candidate SN (T-SN2) including an indication indicating that this is a second hop CPC and receiving an SN Addition Request Ack including at least one SCG configuration associated to at least one of the one or more target candidate PSCells requested by the first network node 511. The transmitting of an SN Addition Request for CPC to a second target candidate SN (T-SN2) may be performed before or after the execution of a first hop CPC towards the first target candidate SN (T-SN 1).

### Action 1950

The first network node 511 transmits an SN Modification request to the second network node 512 in case an intra-SN-CPC first hop configuration is initiated by the first network node 511.

The first network node 511 transmits a Data Forwarding Address Indication to the second network node 512 or the first target candidate SN (T-SN1) in case an inter-SN-CPC configuration is initiated by the first network node 511.

The first network node 511 transmits an SN Addition request to the first target candidate SN T-SN1 in case an inter-SN-CPC first hop configuration is initiated by the first network node 511.

### Action 1960

The first network node 511 triggers an SN release or SCG deactivation procedure to the one or more target candidate SN(s) indicated by the second network node 512 or the first target candidate SN (T-SN1) for the one or more target candidate PSCells in the second hop CPC configuration.

According to embodiments herein, a method performed in the second network node 512 for handling multi-hop configuration of conditional primary secondary cell change or primary secondary cell group cell change (CPC) for the communication device 530, 531 will be described with reference to FIG. 20. The communication device 530, 531 is configured with dual connectivity with a master cell group (MCG) managed by the first network node 511, and a secondary cell group (SCG) managed by a second network node 512, in a wireless communication network 500. The method comprises the following actions which may be performed in any suitable order.

### Action 2010

The second network node 512 transmits a request for CPC to the first network node 511 or the communication device 530. The request for CPC may comprise any one or more of the following information:
an indication indicating allowing multi-hop CPC;
an indication indicating the maximum number of allowed CPC hops;
a configuration for a first hop intra-SN CPC;
a configuration for subsequent hops intra-SN CPCs;
a configuration for a second hop inter-SN CPC to another target candidate SN;
an indication indicating whether a next CPC hop configuration is allowed.
   The request for CPC may be any one of the following messages:
an SN Change Required message transmitted to the first network node 511 in case the second network node 512 decides to configure inter-SN CPC towards a first target candidate SN (T-SN1);
an SN Modification Required message transmitted to the first network node 511 in case the second network node 512 decides to configure an intra-SN CPC and initiate a configuration for a second hop intra-SN CPC or inter-SN CPC towards a first target candidate SN (T-SN1);
a Reconfiguration message transmitted to the communication device 530 in case the second network node 512 decides to modify a first hop intra CPC to include configuration of a second hop intra CPC.

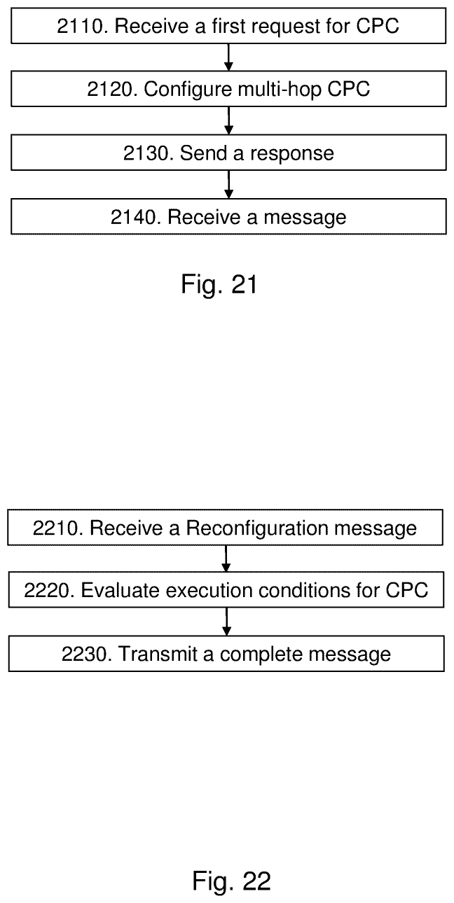

According to embodiments herein, a method performed in a first target candidate secondary node (T-SN1) for handling multi-hop configuration of conditional primary secondary cell change or primary secondary cell group cell change (CPC) for the communication device 530, 531 will be described with reference to FIG. 21. The communication device 530, 531 is configured with dual connectivity with a master cell group (MCG) managed by the first network node 511, and a secondary cell group (SCG) managed by a second network node 512, in a wireless communication network 500. The method comprises the following actions which may be performed in any suitable order.

### Action 2110

The first target candidate secondary node (T-SN1) receives a request for CPC from the first network node 511.

### Action 2120

The first target candidate secondary node (T-SN1) configures multi-hop CPC by configuring a first hop CPC and including information on a second hop CPC or configuring a first hop CPC and initiating a configuration for a second hop CPC towards a second candidate secondary node (T-SN2).

### Action 2130

The first target candidate secondary node (T-SN1) sends a response message to the first network node 511. The response message may comprise one or more of the following information:
iv. an indication that this is a multi-hop CPC configuration,
v. identifier(s) of one or more target candidate cells for the next or a later hop CPC configuration,
vi. identifier(s) of one or more Target Candidate SN(s) associated to the one or more target candidate cells.

The method may further comprise the following action:

### Action 2140

The first target candidate secondary node (T-SN1) may receive a message from the first network node 511 confirming completion of the second hop CPC configuration.

According to some embodiments herein, a first method performed in a communication device 530, 531 for handling multi-hop configuration of conditional primary secondary cell change or primary secondary cell group cell change (CPC) for the communication device 530, 531 will be described with reference to FIG. 22. The communication device 530, 531 is configured with dual connectivity with a master cell group (MCG) managed by the first network node 511, and a secondary cell group (SCG) managed by a second network node 512, in a wireless communication network 500. The method comprises the following actions which may be performed in any suitable order.

### Action 2210

The communication device 530, 531 receives a Reconfiguration message from the first network node 511 or the second network node 512. The Reconfiguration message comprises information on configuration of a first hop CPC and encapsulated information concerning future CPC hops.

### Action 2220

The communication device 530, 531 evaluates execution conditions for CPC candidates based on the content of the Reconfiguration message. The communication device 530, 531 may evaluate the execution conditions for the first hop CPC candidates, and then after the execution of the first hop CPC, evaluate the execution conditions for the second hop CPC candidates, and so on for the future CPC hops.

### Action 2230

The communication device 530, 531 transmits a complete message in response to the Reconfiguration message to the first network node 511 or the second network node 512.

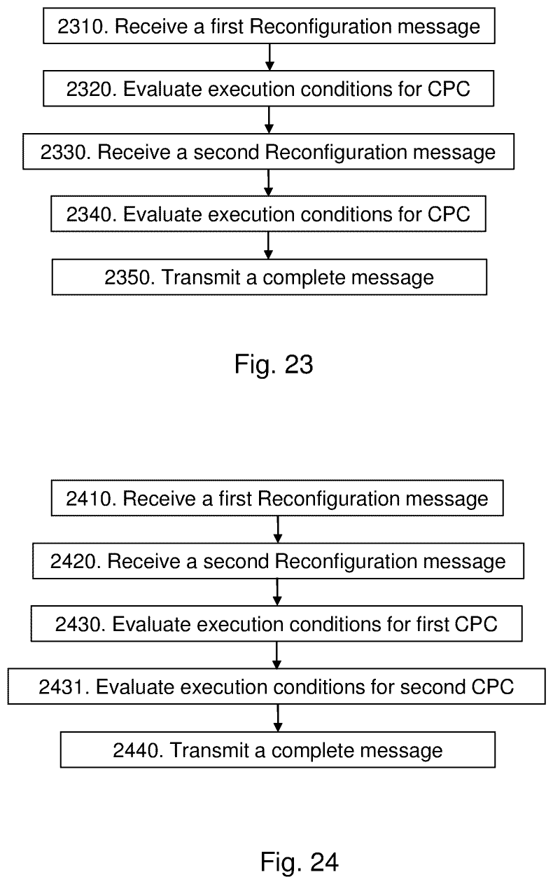

According to some embodiments herein, a second method performed in a communication device 530, 531 for handling multi-hop configuration of conditional primary secondary cell change or primary secondary cell group cell change (CPC) for the communication device 530, 531 will be described with reference to FIG. 23. The communication device 530, 531 is configured with dual connectivity with a master cell group (MCG) managed by the first network node 511, and a secondary cell group (SCG) managed by a second network node 512, in a wireless communication network 500. The method comprises the following actions which may be performed in any suitable order.

### Action 2310

The communication device 530, 531 receives a first Reconfiguration message from the first network node 511. The first Reconfiguration message contains information on a first hop CPC configuration.

### Action 2320

The communication device 530, 531 evaluates execution conditions for CPC candidates based on the content of the first Reconfiguration message.

### Action 2330

The communication device 530, 531 receives a second Reconfiguration message from the first network node 511. The second Reconfiguration message comprises information on a second hop CPC configuration.

### Action 2330

The communication device 530, 531, after the execution of the first hop CPC, evaluates execution conditions for CPC candidates based on the content of the second Reconfiguration message.

### Action 2330

The communication device 530, 531 transmits a Reconfiguration Complete message in response to the second Reconfiguration message to the first network node 511.

According to some embodiments herein, a third method performed in a communication device 530, 531 for handling multi-hop configuration of conditional primary secondary cell change or primary secondary cell group cell change (CPC) for the communication device 530, 531 will be described with reference to FIG. 24. The communication device 530, 531 is configured with dual connectivity with a master cell group (MCG) managed by the first network node 511, and a secondary cell group (SCG) managed by a second network node 512, in a wireless communication network 500. The method comprises the following actions which may be performed in any suitable order.

### Action 2410

The communication device 530, 531 receives a first Reconfiguration message from the first network node 511. The first Reconfiguration message contains information on a first hop CPC configuration.

### Action 2420

The communication device 530, 531 receives a second Reconfiguration message from the first network node (511). The second Reconfiguration message comprises information on a second hop CPC configuration and an indication indicating the CPC configuration is to be applied to the second CPC hop.

### Action 2430

The communication device 530, 531 evaluates execution conditions for the first hop CPC candidates based on the content of the first Reconfiguration message.

### Action 2431

The communication device 530, 531 evaluates, after the execution of the first hop CPC, execution conditions for the second hop CPC candidates based on the content of the second Reconfiguration message.

### Action 2440

The communication device 530, 531 transmits a complete message to the first network node 511.

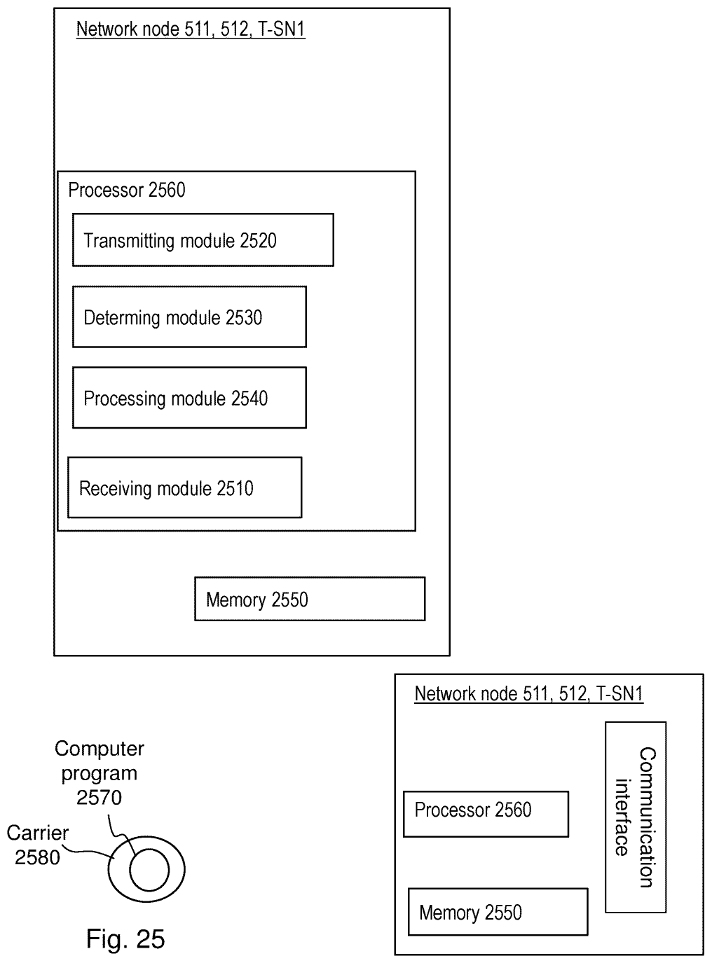

FIG. 25 is a schematic block diagram illustrating an example embodiment of a network node, which may be the first network node 511, the second network node or the first target candidate secondary node (T-SN1).

To perform the method in the first network node 511, the second network node 512, the first target candidate secondary node (T-SN1), the first network node 511, the second network node 512, the first target candidate secondary node (T-SN1) may comprise modules as shown in FIG. 25. The first network node 511, the second network node 512, the first target candidate secondary node (T-SN1) may comprise a receiving module 2510, a transmitting module 2520, a determining module 2530, a processing module 2540, a memory 2550 etc.

The network node 511, 512 may be a MN, S-SN and target candidate T-SN1 and is configured to perform any one of the actions described above regarding to the MN, S-SN and target candidate T-SN1.

The method according to embodiments herein may be implemented through one or more processors, such as the processor 1960 in the network node 511, 512 together with computer program code for performing the functions and actions of the embodiments herein. The program code mentioned above may also be provided as a computer program product, for instance in the form of computer readable medium or a data carrier 2580 carrying computer program code 2570, as shown in FIG. 25, for performing the embodiments herein when being loaded into the network node 511, 512. One such carrier may be in the form of a CD ROM disc. It is however feasible with other data carriers such as a memory stick. The computer program code may furthermore be provided as pure program code on a server or a cloud and downloaded to the network node 511, 512.

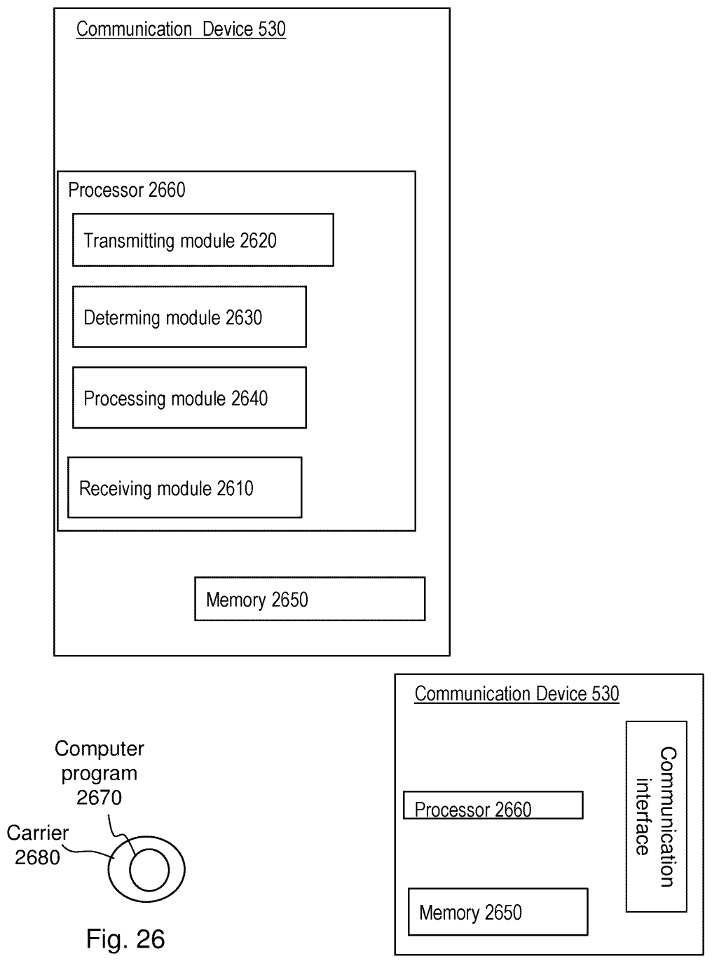

FIG. 26 shows an example embodiment for the communication device 530 in which a method performed by the communication device 530 may be implemented. The communication device 530 comprises modules as shown in FIG. 26. The communication device 530 comprises a receiving module 2610, a transmitting module 2620, a determining module 2630, a processing module 2640, a memory 2650 etc. The communication device 530 is configured to perform any one of the method actions described above regarding to the UE.

The method according to embodiments herein may be implemented through one or more processors, such as the processor 2660 in the UE 530 together with computer program code for performing the functions and actions of the embodiments herein. The program code mentioned above may also be provided as a computer program product, for instance in the form of computer readable medium or a data carrier 2680 carrying computer program code 2670, as shown in FIG. 26, for performing the embodiments herein when being loaded into the UE 530. One such carrier may be in the form of a CD ROM disc. It is however feasible with other data carriers such as a memory stick. The computer program code may furthermore be provided as pure program code on a server or a cloud and downloaded to the communication device 530.

1. A method performed in a first network node for handling multi-hop configuration of conditional primary secondary cell change or primary secondary cell group cell change, CPC, for a communication device configured with dual connectivity with a master cell group, MCG, managed by the first network node, and a secondary cell group, SCG, managed by a second network node, in a wireless communication network, the method comprising:
transmitting a request for CPC to at least one of the second network node and a first target candidate Secondary Node, SN, (T-SN1);
receiving a message from at least one of the second network node and the first target candidate SN (T-SN1) in response to the request for CPC, wherein the message comprises one or more of the following information:
a. a first indication indicating that the CPC configuration is a multi-hop CPC configuration,
b. a second indication about whether it is time critical to configure a first hop CPC;
c. a third indication about how many hops ahead to be configured;
d. identifiers of one or more target candidate primary secondary cells, PSCells, for the second hop CPC configuration, and
e. identifiers of one or more target candidate secondary nodes (T-SN2) associated to the one or more target candidate PSCells; and
configuring multi-hop CPC for the communication device based on the received message.

2. The method according to claim 1, wherein the request for CPC comprises one or more of the following:
1. a configuration for the first hop CPC or a part of configuration to be applied at the first hop CPC;
2. a first request indication on which hop of the multi-hop CPC that is requested; and
3. a second request indication on the maximum number of CPC hops the communication device supports.

3. The method according to claim 1, wherein configuring the multi-hop CPC for the communication device based on the received message comprises:
creating a Reconfiguration message that contains information about both a first hop CPC configuration and a next hop CPC configuration; and
sending this Reconfiguration message to the communication device.

4. The method according to claim 1, further comprising:
triggering an SN Addition procedure for CPC to at least one of:
the one or more target candidate SN(s) indicated by the second network node; and
the first target candidate SN (T-SN1) for the one or more target candidate PSCells in the second hop CPC configuration.

5. The method according to claim 1, further comprising:
triggering at least one of an SN release or SCG deactivation procedure to the one or more target candidate SN(s) indicated by the second network node or the first target candidate SN (T-SN1) for the one or more target candidate PSCells in the second hop CPC configuration.

6. The method according to claim 1, wherein configuring multi-hop CPC for the communication device based on the received message comprises at least one of the following:
1. creating a first Reconfiguration message that contains information about a first hop CPC configuration and sending the first Reconfiguration message to the communication device, then creating a second Reconfiguration message that contains information about a next hop CPC configuration and send this second Reconfiguration message to the communication device; and
2. creating a first Reconfiguration message that contains information about the first hop CPC configuration and sending the first Reconfiguration message to the communication device, then storing information about the next hop CPC configuration and sending the second Reconfiguration message containing the information about the next hop CPC configuration after the execution of the first hop CPC to the communication device.

7. The method according to claim 1, further comprising:
transmitting an SN Modification request to the second network node in case an intra-SN-CPC first hop configuration is initiated by the first network node.

8. The method according to claim 1, further comprising:
transmitting a Data Forwarding Address Indication to the second network node or the first target candidate SN (T-SN1) in case an inter-SN-CPC configuration is initiated by the first network node.

9. The method according to claim 1, further comprising:
transmitting an SN Addition request to the first target candidate SN (T-SN1) in case an inter-SN-CPC first hop configuration is initiated by the first network node.

10. The method according to claim 1, further comprising:
receiving an SN Change Required from the second network node in case an inter-SN-CPC first hop configuration is initiated by the second network node.

11. The method according to claim 1, further comprising:
receiving an SN Modification Required from the second network node in case an intra-SN-CPC first hop configuration is initiated by the second network node.

12. The method according to claim 4, wherein triggering an SN Addition procedure for CPC comprises:
transmitting an SN Addition Request for CPC to a second target candidate SN (T-SN2) including an indication indicating that this is the second hop CPC;
receiving an SN Addition Request Ack including at least one SCG configuration associated to at least one of the one or more target candidate PSCells requested by the first network node.

13. The method according to claim 12, wherein transmitting the SN Addition Request for CPC to the second target candidate SN (T-SN2) is performed after the execution of the first hop CPC towards the first target candidate SN (T-SN 1).

14. The method according to claim 12, wherein transmitting the SN Addition Request for CPC to the second target candidate SN (T-SN2) is performed before the execution of the first hop CPC towards the first target candidate SN (T-SN 1).

15. A method performed in a second network node for handling multi-hop configuration of conditional primary secondary cell change or primary secondary cell group cell change, CPC, for a communication device configured with dual connectivity with a master cell group, MCG, managed by a first network node, and a secondary cell group, SCG, managed by the second network node, in a wireless communication network, the method comprising:
transmitting a request for CPC to the first network node or the communication device, wherein the request for CPC comprises any one or more of the following information:
a. a first indication indicating allowing multi-hop CPC;
b. a second indication indicating the maximum number of allowed CPC hops;
c. a first configuration for a first hop intra-SN CPC;
d. a second configuration for subsequent hops intra-SN CPCs, the subsequent hops intra-SN CPCs comprising a second hop intra-SN CPC;
e. a third configuration for a second hop inter-SN CPC to another target candidate SN; and
f. an third indication indicating whether a next CPC hop configuration is allowed.

16. The method according to claim 15 wherein the request for CPC is any one of the following messages:
1. an SN Change Required message transmitted to the first network node in case the second network node decides to configure inter-SN CPC towards a first target candidate SN (T-SN1);
2. an SN Modification Required message transmitted to the first network node in case the second network node decides to configure an intra-SN CPC and initiate a configuration for the second hop intra-SN CPC or inter-SN CPC towards the first target candidate SN (T-SN1); and
3. a Reconfiguration message transmitted to the communication device in case the second network node decides to modify the first hop intra-SN CPC to include configuration of the second hop intra-SN CPC.

17. A method performed in a first target candidate secondary node (T-SN1) for handling multi-hop configuration of conditional primary secondary cell change or primary secondary cell group cell change, CPC, for a communication device configured with dual connectivity with a master cell group, MCG, managed by a first network node, and a secondary cell group, SCG, managed by the second network node, in a wireless communication network, the method comprising:
receiving a request for CPC from the first network node;
configuring multi-hop CPC by configuring a first hop CPC and including information on a second hop CPC or configuring the first hop CPC and initiating a configuration for the second hop CPC towards a second candidate secondary node (T-SN2);
sending a response message to the first network node, wherein the response message comprises one or more of the following information:
1. an indication that this is a multi-hop CPC configuration,
2. one or more first identifiers of one or more target candidate cells for the next or a later hop CPC configuration, and
3. one or more second identifiers of one or more Target Candidate SNs associated to the one or more target candidate cells.

18. The method according to claim 17, further comprising:
receiving a message from the first network node confirming completion of the second hop CPC configuration.

19-26. (canceled)
